(19) United States
(12) Patent Application Publication
(10) Pub. No.: US 2025/0043115 A1
(43) Pub. Date: Feb. 6, 2025

(54) RUBBER COMPOSITIONS WITH GROUND CURED RUBBER, METHODS OF MAKING THE SAME, AND ARTICLES COMPRISING THE SAME

(71) Applicant: NIKE, Inc., Beaverton, OR (US)

(72) Inventor: Khoi N. Du, Ho Chi Minh City (VN)

(21) Appl. No.: 18/433,646

(22) Filed: Feb. 6, 2024

Related U.S. Application Data
(60) Provisional application No. 63/516,901, filed on Aug. 1, 2023.

(51) Int. Cl. C08L 9/00

(52) U.S. Cl. CPC C08L 9/00; C08L 2205/035; C08L 2207/24

(57) ABSTRACT

The present disclosure is directed to a rubber composition and methods for preparing and using the same. In one aspect, the rubber composition comprises a polymeric component and a curing package comprising sulfur and optionally a curing accelerator; wherein the polymeric component comprises or consists of 100 parts of an uncured rubber component comprising at least one uncured rubber, at least 5 parts per hundred rubber (phr) ground cured rubber, and at least 1 phr of a macrocyclic polymer additive comprising a macrocyclic polymer. In a further aspect, the rubber composition can be processed using existing equipment. In a still further aspect, the rubber composition is resistant to scorching and is thus compatible with extended periods of storage prior to molding and vulcanization.

### CROSS REFERENCE TO RELATED APPLICATIONS

This application claims the benefit of U.S. Provisional Application No. 63/516,901 filed on Aug. 1, 2023, which is incorporated herein by reference in its entirety.

### BACKGROUND

The design of athletic equipment and apparel as well as footwear involves a variety of factors from the aesthetic aspects, to the comfort and feel, to the performance and durability. While design and fashion may be rapidly changing, the demand for increasing performance in the market is unchanging. At the same time, there is an increased desire for materials which include higher proportions of recycled content without sacrificing performance. To balance these demands, designers employ a variety of materials and designs for the various components that make up athletic equipment and apparel as well as footwear.

### BRIEF DESCRIPTION OF THE DRAWINGS

Further aspects of the present disclosure will be readily appreciated upon review of the detailed description, described below, when taken in conjunction with the accompanying drawings.

FIGS. 1A-1M illustrate various articles of footwear, apparel, and athletic equipment, including containers, electronic equipment, and vision wear, that are or comprise the rubber compositions in accordance with the present disclosure, while FIGS. 1N(a)-1N(b) illustrate additional details regarding different types of footwear.

FIG. 2 shows a torque curve from the Mooney Viscosity Test for selected samples containing macrocyclic polymer additive but no ground rubber. A description of the Mooney Viscosity Test is provided in the Examples. (A0=no macrocyclic polymer additive, A3=3 phr macrocyclic polymer additive, A6=6 phr macrocyclic polymer additive, and A9=9 phr macrocyclic polymer additive.) Increasing the amount of macrocyclic polymer additive results in lower Mooney Viscosity.

FIG. 3A shows the effect of the macrocyclic polymer additive on TS2. FIG. 3B shows the effect of the macrocyclic polymer additive on T90. The effect of the macrocyclic polymer additive is not apparent for TS2; however, high amounts of the macrocyclic polymer additive (on the order of 9 phr) cause a significant delay in T90 at Day 1. Without wishing to be bound by theory, the macrocyclic polymer additive could be contributing to relaxation of the composition. A description of how to measure TS2 and T90 is provided in the Examples.

FIG. 4A shows the effect of inclusion of 33 phr ground rubber on TS2 in compositions containing no macrocyclic polymer additive. FIG. 4B shows the effect of inclusion of 33 phr ground rubber on T90 in compositions containing no macrocyclic polymer additive. Without wishing to be bound by theory, with the addition of ground rubber, rheology is shortened, a phenomenon known as scorching, or a premature reaction that causes partial vulcanization of rubber. (A0=no ground rubber, A33=33 phr ground rubber.)

FIG. 5A shows the effect of inclusion of 33 phr ground rubber on TS2 in compositions containing various amounts of macrocyclic polymer additive. FIG. 5B shows the effect of inclusion of 33 phr ground rubber on T90 in compositions containing various amounts of macrocyclic polymer additive. Without wishing to be bound by theory, the macrocyclic polymer additive, which is an unsaturated polymer that is reactive towards curing compounds, masks the ground rubber surface and absorbs and/or reacts with curing compounds from the ground rubber that migrate during processing. As a result, rheology is prolonged, allowing for efficient management of the disclosed compositions. (A0=no ground rubber and no macrocyclic polymer additive; A33=33 phr ground rubber and no macrocyclic polymer additive, A3-33=33 phr ground rubber and 3 phr macrocyclic polymer additive; A6-33=33 phr ground rubber and 6 phr macrocyclic polymer additive; A9-33==33 phr ground rubber and 9 phr macrocyclic polymer additive.)

FIG. 6A shows decreases in tensile strength with increasing amounts of ground rubber in exemplary rubber compositions. FIG. 6B shows decreases in elongation with increasing amounts of ground rubber in exemplary rubber compositions. Tensile strength and elongation do not change significantly with increasing amounts of macrocyclic polymer additive. Exemplary methods for determining tensile strength and elongation are provided in the Examples.

FIG. 7A shows moderate decreases in tensile strength with increasing amounts of ground rubber in exemplary rubber compositions. FIG. 7B shows decreases in elongation with increasing amounts of ground rubber in exemplary rubber compositions. Tensile strength and elongation do not change significantly with increasing amounts of macrocyclic polymer additive.

FIG. 8A shows no observable change in tensile strength with changing amount of macrocyclic polymer additive when amount of ground cured rubber is held constant at 11 phr; when ground cured rubber is held constant at 33 phr, tensile strength increases with the addition of macrocyclic polymer additive. FIG. 8B shows that elongation shows no observable change at 3-6 phr of macrocyclic polymer additive but at 9 phr macrocyclic polymer additive, elongation improves when ground cured rubber is held constant at 11 phr; at 33 phr ground cured rubber, elongation also improves with the addition of macrocyclic polymer additive.

FIG. 9 shows abrasion resistance of various rubber compositions as measured using the DIN abrasion resistance test described further in the Examples. Without wishing to be bound by theory, the addition of ground rubber should reduce DIN abrasion resistance since ground rubber acts as a non-reinforcing filler. Furthermore, it would be expected that the macrocyclic polymer additive would also reduce DIN abrasion resistance since polymer strength of the additive is relatively week. However, when used in combination, the macrocyclic polymer additive and ground rubber synergetically improve DIN abrasion resistance. Without wishing to be bound by theory, the macrocyclic polymer additive may convert ground rubber into a reinforcing filler through surface modification. (A0=no ground rubber and no macrocyclic polymer additive; A3=no ground rubber but 3 phr macrocyclic polymer additive; A9=no ground rubber but 9 phr macrocyclic polymer additive; A0-33=no macrocyclic polymer additive but 33 phr ground rubber; A3-33=3 phr macrocyclic polymer additive and 33 phr ground rubber; A6-33=6 phr macrocyclic polymer additive and 33 phr ground rubber; A9-33=9 phr macrocyclic polymer additive and 33 phr ground rubber.)

### DESCRIPTION

In the manufacturing process for cured rubber articles, including articles or components of articles of footwear, apparel or sporting equipment, a significant proportion of waste is generated. This waste can be recycled by grinding cured scrap rubber into small granules, which can be mixed with uncured (green) rubber, such as virgin rubber or devulcanized rubber, in a rubber composition and cured to make new cured rubber articles. However, incorporating ground cured rubber in such compositions presents problems, particularly when higher concentrations of ground cured rubber are used, such as when at least 5 parts per hundred parts uncured rubber (phr), or at least 10 phr. or more of ground cured rubber are used. For example, addition of ground cured rubber to a new rubber composition can result in poor mixing, a short storage time before the rubber composition must be cured, and poor physical properties of cured rubber articles made from the rubber composition, which has resulted in it being realistic to use only low concentrations of ground cured rubber in new rubber compositions. When only low concentrations of ground cured rubber can be added to new rubber compositions, the problem of reducing or reusing waste remains largely unaddressed. Previous attempts to recycle waste rubber include reclaiming, also known as devulcanization, but this process is energy intensive and requires high capital investment. In another aspect, previous attempts to incorporate high amounts of ground cured rubber into new rubber compositions experienced difficulties in processing including poor mixing, requirements for large amounts of machine time, and requirements for high heat to counteract increased viscosity; however, these same efforts tended to increase premature curing of the rubber.

The present disclosure relates to rubber compositions including ground cured rubber, uncured rubber, and a macrocyclic polymer additive; methods of making such compositions, method for manufacturing cured rubber articles from such compositions, and cured rubber articles formed from such compositions, including articles or components of articles of footwear, apparel or sporting equipment, including rubber outsoles for articles of footwear.

It has been found that including a macrocyclic polymer additive in combination with ground cured rubber can overcome one or more of the problems associated with incorporating ground cured rubber into new rubber compositions as well as problems associated with the cured rubber articles made from such rubber compositions. In one aspect, use of at least 1 phr or more of the macrocyclic polymer additive, along with at least 5 phr ground uncured rubber, in a rubber composition comprising 100 phr uncured rubber and a curing package, has been found to be particularly effective in overcoming one or more of these problems.

As ground cured rubber includes solid particles of thermoset rubber, including higher concentrations of ground cured rubber makes the new rubber composition more difficult to mix, and can lead to the new rubber composition being poorly mixed and cured rubber articles made from the poorly mixed rubber composition having properties which are inhomogeneous. While using longer mixing times can improve the degree of mixing, using longer mixing times for rubber compositions comprising ground cured rubber presents other problems.

Unexpectedly, it has been found that adding a macrocyclic polymer additive to a rubber composition comprising ground cured rubber, an uncured (green) rubber component, a curing package, and optionally one or more additional additive, can provide one or more benefits to the rubber composition, the process of making the rubber composition, cured rubber articles made from the cured rubber composition, and/or methods of making the cured rubber articles. In one aspect, using at least 1 part of the macrocyclic polymer additive per 100 parts of the uncured rubber component in the rubber composition has been found to provide these benefits. In another aspect, the rubber composition can comprise at least 1 phr of the macrocyclic polymer additive and at least 5 phr of ground rubber.

The present disclosure can be described in accordance with the following numbered aspects, which should not be confused with the claims.

In accordance with aspect 1, the present disclosure is directed to a rubber composition comprising:
a polymeric component, and
a curing package comprising sulfur and optionally a curing accelerator;
wherein the polymeric component comprises or consists of 100 parts of an uncured rubber component comprising at least one uncured rubber, ground cured rubber, and a macrocyclic polymer additive comprising a macrocyclic polymer.

In accordance with aspect 2, the present disclosure is directed to the rubber composition of aspect 1, wherein the rubber composition comprises at least 1 phr of the macrocyclic polymer additive; optionally wherein the rubber composition comprises from about 1 to about 20 phr, about 3 to about 15 phr, about 5 phr to about 12 phr, about 5 phr to about 10 phr, or from about 9 to about 12 phr of the macrocyclic polymer additive.

In accordance with aspect 3, the present disclosure is directed to the rubber composition of aspect 1 or 2, wherein a ratio of phr of macrocyclic polymer additive to phr uncured rubber is from about 1:100 to about 2:5, optionally from about 1:50 to about 1:5.

In accordance with aspect 4, the present disclosure is directed to the rubber composition of any one of aspects 1-3, wherein a ratio of macrocyclic polymer additive to ground cured rubber is from about 1:40 to about 4:1, optionally from about 1:5 to about 1:2.

In accordance with aspect 5, the present disclosure is directed to the rubber composition of any one of aspects 1-4, wherein the macrocyclic polymer includes at least 24 carbon atoms or at least 40 carbon atoms or at least 64 carbon atoms or at least 80 carbon atoms bonded to each other in a ring structure by a plurality of carbon-carbon single bonds and a plurality of carbon-carbon double bonds.

In accordance with aspect 6, the present disclosure is directed to the rubber composition of aspect 5, wherein, in the plurality of carbon-carbon double bonds of the macrocyclic polymer, from about 60 to about 100%, or from about 75 to about 85% of the double bonds are in a trans configuration.

In accordance with aspect 7, the present disclosure is directed to the rubber composition of aspect 5 or 6, wherein, in the ring structure, a majority of the plurality of carbon-carbon double bonds are separated by from 4 to 12, 5 to 11, or 6 to 10 singly bonded carbon atoms; or wherein each of the plurality of carbon-carbon double bonds are separated by 4 to 12, 5 to 11, or 6 to 10 singly bonded carbon atoms; or a majority of the plurality of carbon-carbon double bonds occur every 8 carbon atoms; or individual bonds of the plurality of carbon-carbon double bonds occur every 8 carbon atoms.

In accordance with aspect 8, the present disclosure is directed to the rubber composition of any one of aspects 1-7, wherein the macrocyclic polymer additive has a molecular weight of from about 50,000 g/mol to about 250,000 g/mol, about 75,000 g/mol to about 225,000 g/mol, about 100,000 g/mol to about 200,000g/mol, or about 125,000 g/mol to about 175,000 g/mol.

In accordance with aspect 9, the present disclosure is directed to the rubber composition of any one of aspects 1-8, wherein the macrocyclic polymer has a melting temperature less than 100 degrees Celsius, less than 90 degrees Celsius, less than 80 degrees Celsius, less than 70 degrees Celsius, or less than 60 degrees Celsius, optionally from about 20 degrees Celsius to about 100 degrees Celsius, from about 30 degrees Celsius to about 90 degrees Celsius, from about 40 degrees Celsius to about 80 degrees Celsius, or from about 50 degrees Celsius to about 70 degrees Celsius.

In accordance with aspect 10, the present disclosure is directed to the rubber composition of any one of aspects 1-9, wherein the macrocyclic polymer comprises trans-polyoctenamer (TOR).

In accordance with aspect 11, the present disclosure is directed to the rubber composition of any one of aspects 1-10, wherein the uncured rubber component comprises butyl rubber, styrene-butadiene rubber (SBR), isoprene rubber, chloroprene rubber, ethylene propylene diene monomer (EPDM) rubber, neoprene rubber, butadiene rubber, nitrile rubber, natural rubber, or any combination thereof.

In accordance with aspect 12, the present disclosure is directed to the rubber composition of any one of aspects 1-11, wherein an average particle size of the ground cured rubber is of from about 25 to about 40 mesh.

In accordance with aspect 13, the present disclosure is directed to the rubber composition of any one of aspects 1-12, wherein the ground cured rubber comprises or consists of ground recycled cured rubber, optionally wherein the recycled rubber comprises or consists of recycled footwear rubber, optionally wherein the recycled footwear rubber comprises recycled cured rubber from a post-consumer article of footwear, cured rubber from a rejected article of footwear or rejected component of an article of footwear, waste cured rubber from production of an article of footwear or component of an article of footwear, or any combination thereof.

In accordance with aspect 14, the present disclosure is directed to the rubber composition of any one of aspects 1-13, wherein the ground cured rubber comprises less than 5 phr carbon black, or wherein the ground cured rubber is essentially free of byproducts of 2-mercaptobenzothiazole, or wherein the ground cured rubber comprises less than 5 phr carbon black and is essentially free of byproducts of 2-mercaptobenzothiazole; optionally wherein the ground cured rubber is essentially free of ground tire rubber.

In accordance with aspect 15, the present disclosure is directed to the rubber composition of any one of aspects 1-14, wherein the rubber composition comprises at least 5 phr of the ground cured rubber.

In accordance with aspect 16, the present disclosure is directed to the rubber composition of aspect 15, wherein the rubber composition comprises from about 5 to about 40 phr ground cured rubber, optionally from about 10 to about 40 phr ground cured rubber, or from about 20 to about 35 phr ground cured rubber.

In accordance with aspect 17, the present disclosure is directed to the rubber composition of any one of aspects 1-16, wherein the rubber composition further comprises from about 0.5 phr to about 5 phr of a process oil, optionally wherein the process oil comprises an oil from a non-petroleum source, optionally wherein the process oil comprises or consists of soybean oil.

In accordance with aspect 18, the present disclosure is directed to the rubber composition of any one of aspects 1-17, wherein the rubber composition further comprises an additive chosen from zinc oxide, a processing aid, an anti-oxidant, a wax, a homogenizer, a curing activator, a filler, a colorant, or any combination thereof.

In accordance with aspect 19, the present disclosure is directed to the rubber composition of any one of aspects 1-18, wherein the curing package comprises from about 0.2 phr to about 10 phr, optionally from about 0.5 phr to about 7 phr, or from about 1 to about 5 phr of sulfur.

In accordance with aspect 20, the present disclosure is directed to the rubber composition of any one of aspects 1-19, wherein the curing package comprises or consists of from about 0 phr to about 10, optionally from about 0.5 phr to about 7 phr, or from about 1 to about phr of the curing accelerator.

In accordance with aspect 21, the present disclosure is directed to a method for making a rubber composition, the method comprising:
(a) admixing an uncured rubber component, ground cured rubber, and a macrocyclic polymer additive to form a polymeric component of a rubber composition, optionally wherein the admixing comprises coating the ground cured rubber with the macrocyclic polymer additive prior to combining the coated ground rubber with the uncured rubber component;
(b) combining a curing package with the polymeric component to make the rubber composition; and
(c) optionally adding at least one additional component to the rubber composition;
wherein the polymeric component comprises or consists of
100 parts of an uncured rubber component comprising at least one uncured rubber,
at least 5 parts per hundred rubber (phr) ground cured rubber, and
at least 1 phr of a macrocyclic polymer additive comprising a macrocyclic polymer; and
wherein the curing package comprises sulfur and optionally a curing accelerator.

In accordance with aspect 22, the present disclosure is directed to the method of aspect 21, wherein the method comprises (a) admixing the polymeric component prior to (b) combining the curing package with the admixed polymer component; storing the admixed polymeric component for at least 1 day prior to (b) combining the curing package with the stored admixed polymer component.

In accordance with aspect 23, the present disclosure is directed to the method of aspect 21, wherein the (a) admixing the polymeric component and (b) combining the curing package with the polymeric component are conducted simultaneously.

In accordance with aspect 24, the present disclosure is directed to the method of any one of aspects 21-23, wherein the method further comprises storing one or more portions of the rubber composition for at least 3 days; and includes (c) adding the at least one additional component to a stored rubber composition.

In accordance with aspect 25, the present disclosure is directed to the method of aspect 24, wherein the storing comprises storing the one or more portions of the rubber composition for at least 5 days, at least 7 days, or at least 9 days.

In accordance with aspect 26, the present disclosure is directed to the method of aspect 25, wherein the TS2 of a portion of the rubber composition stored for at least 5 days is less than or equal to the TS2 of a portion of the rubber composition stored for 3 days; optionally wherein the TS2 of the portion of the rubber composition stored for at least 7 days is less than or equal to the TS2 of the portion of the rubber composition stored for 3 days; optionally wherein the TS2 of the portion of the rubber composition stored for at least 9 days is less than or equal to the TS2 of the portion of the rubber composition stored for 3 days.

In accordance with aspect 27, the present disclosure is directed to the method of aspect 25 or 26, wherein the T90 of a portion of the rubber composition stored for at least 5 days is less than or equal to the T90 of a portion of the rubber composition stored for 3 days; optionally wherein the T90 of the portion of the rubber composition stored for at least 7 days is less than or equal to the T90 of the portion of the rubber composition stored for 3 days; optionally wherein the T90 of the portion of the rubber composition stored for at least 9 days is less than or equal to the T90 of the portion of the rubber composition stored for 3 days.

In accordance with aspect 28, the present disclosure is directed to the method of any one of aspects 21 to 27, wherein the rubber composition comprises a rubber composition according to any one of aspects 2 to 20.

In accordance with aspect 29, the present disclosure is directed to a rubber composition made by the method of any one of aspects 21-28.

In accordance with aspect 30, the present disclosure is directed to a cured rubber article comprising:
the vulcanized product of a rubber composition including
a polymeric component, and
a curing package comprising sulfur and optionally a curing accelerator;
wherein the polymeric component comprises or consists of
100 parts of an uncured rubber component comprising at least one uncured rubber,
at least 5 parts per hundred rubber (phr) ground cured rubber, and
at least 1 phr of a macrocyclic polymer additive comprising a macrocyclic polymer.

In accordance with aspect 31, the present disclosure is directed to the cured rubber article of aspect 30, wherein the rubber composition comprises a rubber composition according to any one of aspects 2 to 20.

In accordance with aspect 32, the present disclosure is directed to the cured rubber article of aspect 30 or 31, wherein the cured rubber article is a component of an article of footwear, apparel or sporting equipment.

In accordance with aspect 33, the present disclosure is directed to the cured rubber article of aspect 32, wherein the cured rubber article is an outsole for an article of footwear.

In accordance with aspect 34, the present disclosure is directed to a method for making a cured rubber article, the method comprising:
placing a rubber composition in a mold, wherein the rubber composition comprises
100 parts of an uncured rubber component comprising at least one uncured rubber;
at least 5 parts per hundred rubber (phr) ground cured rubber,
at least 1 phr of a macrocyclic polymer additive,
a curing package comprising sulfur and optionally a curing accelerator, and
optionally at least one additional component;
exposing the rubber composition in the mold to vulcanizing conditions for a sufficient period of time to substantially vulcanize the rubber composition, forming the cured rubber article; and
removing the cured rubber article from the mold.

In accordance with aspect 35, the present disclosure is directed to the method of aspect 34, wherein the vulcanizing conditions comprise increasing the temperature of the rubber composition in the mold to a temperature of at least 150 degrees Celsius for at least 300 seconds.

In accordance with aspect 36, the present disclosure is directed to the method of aspect 34 or 35, wherein the rubber composition is a rubber composition according to any one of aspects 1-20.

In accordance with aspect 37, the present disclosure is directed to the method of aspect 34 or 35, wherein the rubber composition is a rubber composition made according to any one of aspects 21-28.

In accordance with aspect 38, the present disclosure is directed to the method of aspect 34 or 35, wherein the cured rubber article is a cured rubber article according to any one of aspects 30-33.

In accordance with aspect 39, the present disclosure is directed to the method of aspect 34 or 35, wherein the cured rubber article is a component of an article of footwear, apparel or sporting equipment.

In accordance with aspect 40, the present disclosure is directed to the method of aspect 39, wherein the cured rubber article is an outsole for an article of footwear.

In accordance with aspect 41, the present disclosure is directed to the cured rubber article of any one of aspects 30-49, wherein the cured rubber article has one or more properties chosen from
a hardness of from about 64 to about 70 Shore A as measured by ASTM 2240-97;
a tensile strength of from about 93 kilograms per square centimeter to about 139 kilograms per square centimeter as measured by ASTM D 638;
an elongation of from about 595% to about 896% as measured by ASTM D 638;
a 300% modulus of from about 31 kilograms per square centimeter to about 41 kilograms per square centimeter as measured by ASTM D 638;
a tear strength of from about 53 kilograms per centimeter to about 86 kilograms per centimeter as measured by ASTM D 624;
a DIN abrasion of from about 0.39 cubic centimeters to about 0.54 cubic centimeters as measured by ASTM D 1053.

In one aspect, adding a macrocyclic polymer additive to one or more components of a rubber composition improves mixing efficiency while reducing mixing time of a subset of the components of the rubber composition or of the overall rubber composition. In many cases, including a macrocyclic polymer additive in the rubber composition can thereby reduce the temperature to which the rubber composition is exposed during mixing and/or reduce the duration over which the rubber composition is exposed to a maximum temperature during mixing. The macrocyclic polymer additive can be combined with the ground cured rubber, and then the combination of the macrocyclic polymer additive and the ground cured rubber can be combined with one or more of the remaining components of the rubber composition, such as the uncured rubber component. Alternatively, the macrocyclic polymer additive can be combined directly with the ground cured rubber and the uncured rubber component of the rubber composition. Optionally, the curing package, alone or in combination with any additional components of the rubber composition, can be combined in a single step. Advantageously, conventional rubber compounding equipment and processes can be used to combine the macrocyclic polymer additive with the ground cured rubber and the other components of the rubber composition. In one aspect, using at least 1 phr of the macrocyclic polymer additive in the rubber composition provides these benefits. In another aspect, the rubber composition comprises 1 phr of the macrocyclic polymer additive and at least 5 phr of ground rubber.

In another aspect, a macrocyclic polymer additive having a relatively low melting point, such as a melting point at or below a maximum desired mixing temperature of the rubber composition (e.g., below 90 degrees Celsius or below 70 degrees Celsius) can be used. Use of a macrocyclic polymer additive having a relatively low melting temperature, but which is a solid at room temperature can allow the macrocyclic polymer additive to be a solid when initially combined with other components at room temperature, simplifying its storage and measurement. Due to the relatively low melting temperature of the macrocyclic polymer additive, it can then melt rapidly during the mixing process, thereby improving mixing efficiency while reducing mixing time and/or mixing temperature of the rubber composition.

In another aspect, a macrocyclic polymer of the macrocyclic polymer additive having a relatively low molecular weight (e.g., a number average molecular weight below 200,000 g/mol or 175,000 g/mol or below 150,000 g/mol) can be used. Use of a low molecular weight macrocyclic polymer can act as a plasticizer in the rubber composition, also improving mixing efficiently. In this way, use of a macrocyclic polymer additive (such as a macrocyclic additive having a relative low melting point or having a relatively low molecular weight or having both a relatively low melting point and a relatively low molecular weight) has been found to shorten mixing times and/or to allow the rubber composition to be exposed to lower temperatures during mixing while improving homogeneity of the resulting mixed rubber composition.

In yet another aspect, the macrocyclic polymer additive has a relatively low melting point as described above, and the macrocyclic polymer of the macrocyclic polymer additive has a relatively low molecular weight as described above.

Another benefit of using shorter mixing times and/or lower mixing temperatures to mix the rubber composition is that shorter mixing times and/or lower mixing temperatures reduce the amount of residual compounds which are extracted from the ground cured rubber component of the rubber composition. Ground cured rubber typically includes compounds such as residual pigments, residual unreacted uncured (green) rubbers, unreacted curing agents, and unreacted curing accelerators, which can migrate to the surface of the ground cured rubber or migrate out of the ground cured rubber. Longer mixing times and/or higher mixing temperatures result in more of these residual components being extracted from the ground cured rubber and mixing with the other components of the new rubber composition. The amount of these residual compounds which will end up in the new rubber composition can be difficult to predict or control, and variations in their concentrations will from batch to batch. These variations in the concentrations of residual compounds can in turn lead to batch-to-batch variability of the physical properties of the cured rubber composition, including variability in color, tensile strength, elongation, tear strength, and such. In one aspect, the mixed rubber composition comprising the macrocyclic polymer additive includes a lower concentration of extracted residual components as compared to an equivalent mixed rubber composition without the macrocyclic polymer additive. Including a macrocyclic polymer additive in the new rubber formulation allows the use of shorter mixing times to achieve more consistent degrees to mixing and more consistent mixing times between batches This in turn reduces the amount of residual compounds extracted from the ground cured rubber during mixing, which leads to more consistent rubber compositions and more batch-to-batch consistency in physical properties of cured rubber articles made from the rubber compositions. In one aspect, the rubber composition comprises at least 1 phr of the macrocyclic polymer additive, wherein the macrocyclic polymer additive comprises a macrocyclic polymer having a ring structure including at least 3 carbon-carbon double bonds which crosslink with components of the rubber composition during curing (vulcanization). In another aspect, the rubber composition comprises at least 5 phr of ground rubber and at least 1 phr of the macrocyclic polymer additive, wherein the macrocyclic polymer additive comprises a macrocyclic polymer having a ring structure including at least 3 carbon-carbon double bonds which crosslink with components of the rubber composition during curing (vulcanization).

When residual unreacted compounds such as uncured rubber, unreacted curing agents, and unreacted curing accelerators are extracted from ground cured rubber into a new rubber composition, these residual unreacted compounds can react with other components of the new rubber composition, such as the uncured rubber component. Often the residual unreacted compounds react prematurely with the other components, such as during mixing or during storage, before the rubber composition is molded and cured (e.g., exposed to conditions to initiate vulcanization of the rubber composition into a cured rubber article). This problem is often referred to as “scorching”, in which the residual unreacted compounds crosslink prematurely with a sufficiently large percentage of the uncured rubber component to increase the viscosity of the rubber composition prematurely, such as during mixing or storage. Scorching of the rubber composition can make it more difficult to mix the rubber composition or to calendar the rubber composition or to press it into a mold. When scorching results in an increase in viscosity of the rubber composition during storage, it shortens the amount of time that the rubber composition can be stored before molding and curing. As it is a common practice to store a rubber composition for future use, or to treat a rubber composition as a “master batch” which is modified by mixing in additional components at a later time. Scorching can significantly reduce the period of time over which a batch of a rubber composition can be used, and thereby leads to increased waste as the batch of rubber composition may scorch to the point it cannot be used before it can be molded and cured. In one aspect, the macrocyclic polymer of the macrocyclic polymer additive includes a plurality of carbon-carbon bonds in its chemical structure, e.g., wherein the ring structure of the macrocyclic polymer includes a plurality of carbon-carbon double bonds separated by a plurality of carbon-carbon single bonds. The plurality of carbon-carbon double bonds can crosslink with the residual unreacted compounds, thereby consuming all or a portion of the residual unreacted compounds extracted from the ground cured rubber. When the macrocyclic polymer reacts with residual unreacted compounds extracted from the ground cured rubber, it makes all or a portion of the residual unreacted compounds unavailable to react with the uncured rubber component of the rubber composition. In this way, the macrocyclic polymer additive reduces or prevents residual unreacted components extracted from the ground cured rubber from having a negative effect on the rubber composition and on the cured rubber made from the rubber composition. The macrocyclic polymer additive can be mixed with the ground cured rubber before the ground cured rubber is combined with the uncured rubber component of the rubber composition. Alternatively, the macrocyclic polymer additive can be mixed directly with the ground cured rubber, and the uncured rubber component. The macrocyclic polymer additive can be mixed directly with the ground cured rubber, the uncured rubber component, the curing package, and optionally with any additives. Combining the macrocyclic polymer additive with the ground cured rubber alone or in combination with the uncured rubber component or in combination with other components of the rubber composition allows the macrocyclic polymer to react with the residual unreacted compounds before they can react with the uncured rubber or to react with the residual unreacted polymers in place of reacting with the uncured rubber in the new rubber composition. As the structure of the macrocyclic polymer includes a plurality of carbon-carbon double bonds in its ring structure, when the macrocyclic polymer reacts with the residual unreacted compounds, it does not negatively affect the properties of the rubber composition or the resulting cured rubber. In one aspect, the rubber composition comprises at least 1 phr of the macrocyclic polymer additive. In another aspect, the rubber composition comprises at least 5 phr of ground cured rubber and at least 1 phr of the macrocyclic polymer additive.

In rubber compounding, fillers which improve properties of a rubber composition are referred to as “reinforcing filles”. Reinforcing fillers can increase the strength or the abrasion resistance or both the strength and abrasion resistance of a rubber composition as compared to an equivalent rubber composition without the reinforcing filler. The size of reinforcing fillers typically plays a large role in their effectiveness, with a large surface area to volume ratio, or a small size and high proportions between their width and length, being important characteristics of a reinforcing filler. Most commonly used reinforcing fillers are particles having dimensions in the nano-scale. Examples of commonly used reinforcing fillers include silica, clays, carbon black, zinc oxide, titanium dioxide, glass, and graphene. When ground cured rubber is used as a filler in a new rubber composition, typically relatively large particle sizes are used having dimensions considerably larger than nano-scale, as it is energy-intensive and wasteful to grind cured rubber into nano-scale particles. Due to the relatively large particle sizes used, ground cured rubber acts as a non-reinforcing filler, as its presence decreases the strength and abrasion-resistance of the resulting cured rubber. This is another reason why relatively low concentrations of ground cured rubber conventionally are added to rubber formulations. In yet another aspect. it has been found that including a macrocyclic polymer additive (e.g., at least 1 phr of the macrocyclic polymer additive) in combination with relatively large sized particles of ground cured rubber (e.g., about 25 to about 40 mesh size) results in the ground cured rubber behaving in the rubber composition as if it were a reinforcing filler, as the strength and abrasion resistance of the rubber composition are improved as compared to an equivalent rubber composition without the macrocyclic polymer additive. It is believed that the macrocyclic polymer binds to and modifies the surface of the ground rubber particles In some cases, the macrocyclic polymer is believed to crosslink with the cured rubber on the surface of the ground rubber particles. When an individual molecule of the macrocyclic polymer includes a plurality of carbon-carbon bonds, it can form crosslinks both with the surface of a ground rubber particle and with uncured rubber in the rubber composition. In this way, the macrocyclic polymers of the macrocyclic polymer additive can form a plurality of crosslinks between the ground rubber particles and the uncured rubber component of the rubber composition, incorporating the ground cured rubber into the crosslinked polymeric network formed by curing uncured rubber (e.g., during vulcanization), and effectively making the ground cured rubber behave more like a reinforcing filler without the need to use nan-scale particles of the ground cured rubber. In one aspect, the rubber composition comprises at least 1 phr of the macrocyclic polymer additive. In another aspect, the rubber composition comprises at least 5 phr of ground cured rubber and at least 1 phr of the macrocyclic polymer additive.

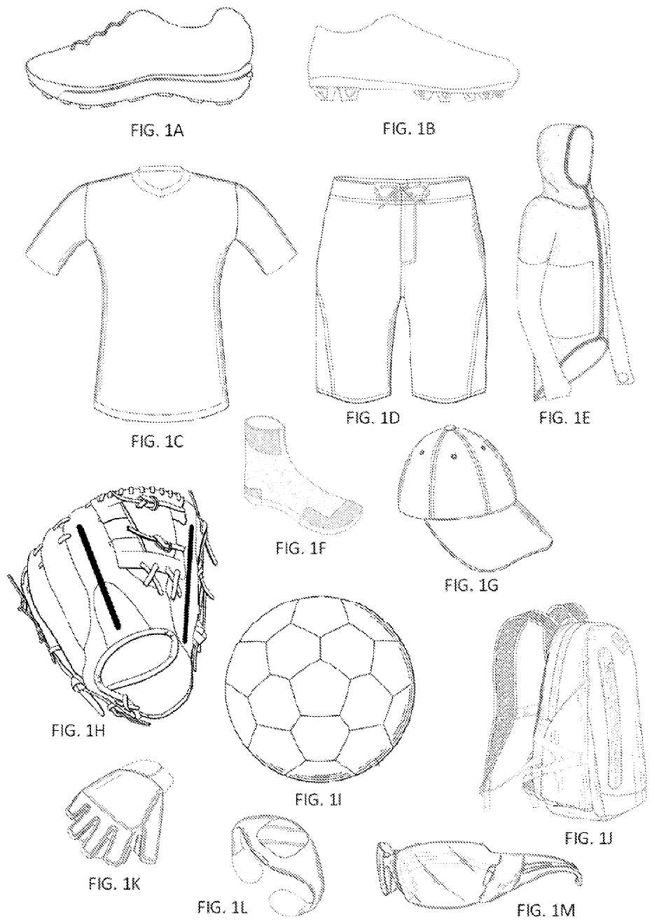

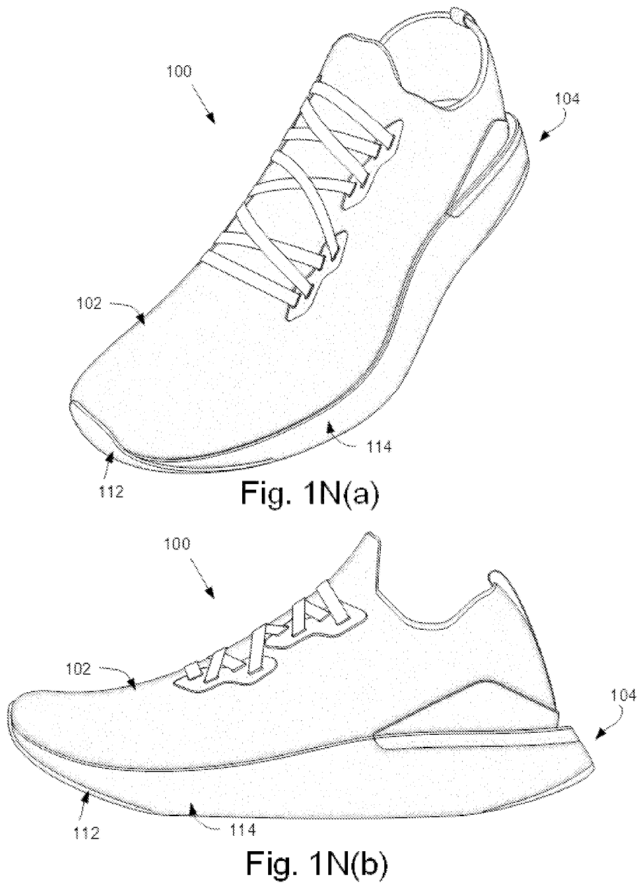

New cured rubber articles including components formed through the curing (i.e., vulcanization) of a rubber composition including ground cured rubber, uncured (green) rubber (e.g., virgin rubber or devulzanized rubber), a macrocyclic polymer additive (comprising a macrocyclic polymer) and a curing package are provided herein. Methods for making such rubber compositions and cured rubber articles formed therefrom have been identified. The disclosed methods and compositions are advantageous in that they overcome many of the difficulties inherent in previous attempts to incorporate ground cured rubber into new rubber compositions and new cured rubber articles. Cured rubber articles formed from these rubber compositions exhibit superior physical performance as compared to cured rubber articles formed from equivalent rubber compositions without the macrocyclic polymer additive. Furthermore, the rubber compositions can be stored for longer periods of time for later use as compared to equivalent rubber compositions without the macrocyclic polymer additive. FIGS. 1A-1M illustrate various articles and components of articles of footwear, apparel, and athletic equipment, including containers, electronic equipment, and vision wear, that are articles or comprise components in accordance with the present disclosure. FIGS. 1N(a)-1N(b) illustrate additional details regarding different types of footwear which can include components comprising the cured rubber described herein.

### RUBBER COMPOSITION

Disclosed herein is a rubber composition comprising a polymeric component, and a curing package comprising sulfur and optionally a curing accelerator. The polymeric component comprises or consists of 100 parts of an uncured rubber component comprising at least one uncured rubber, ground cured rubber, and a macrocyclic polymer additive comprising a macrocyclic polymer. In one aspect, the rubber composition comprises at least 1 parts per hundred rubber (phr) of the macrocyclic polymer additive. In another aspect, the rubber composition comprises at least 5 phr of the ground cured rubber, and at least 1 phr of the macrocyclic polymer additive.

In a further aspect, the rubber composition comprises at least 3 phr of the macrocyclic polymer additive. The rubber composition may comprise at least 5 phr of the macrocyclic polymer additive. The rubber composition may comprise at least 6 phr of the macrocyclic polymer additive. The rubber composition may comprise from about 1 to about 20 phr of the macrocyclic polymer additive. The rubber composition may comprise from about 3 phr to about 15 phr of the macrocyclic polymer additive. The rubber composition may comprise from about 5 phr to about 12 phr of the macrocyclic polymer additive. The rubber composition may comprise from about 5 to about 10 phr of the macrocyclic polymer additive. The rubber composition may comprise from about 9 phr to about 12 phr of the macrocyclic polymer additive.

In a still further aspect, in the rubber composition, a ratio of phr of macrocyclic polymer additive to uncured rubber is from about 1:100 to about 2:5. In the rubber composition, a ratio of phr of macrocyclic polymer additive to uncured rubber is from about 1:50 to about 1:5. In an aspect, in the rubber composition, a ratio of macrocyclic polymer additive to ground cured rubber is from about 1:40 to about 4:1. The ratio of phr macrocyclic polymer additive to phr ground cured rubber can be from about 1:5 to about 1:2.

In an aspect, the macrocyclic polymer additive comprises at least 25 weight percent of the macrocyclic polymer, based on a total weight of the macrocyclic polymer additive present in the rubber composition. The macrocyclic polymer additive can comprise at least 75 weight percent of the macrocyclic polymer. The macrocyclic polymer additive can comprise from about 50 weight percent to about 100 weight percent of the macrocyclic polymer. The macrocyclic polymer additive can comprise from about 75 weight percent to about 100 weight percent of the macrocyclic polymer.

In one aspect, in the rubber composition, the macrocyclic polymer includes at least 24 carbon atoms bonded to each other in a ring structure, where the carbon atoms of the ring structure bonded together by a plurality of carbon-carbon single bonds and a plurality of carbon-carbon double bonds. The ring structure can comprise at least 40 carbon atoms. The ring structure can comprise at least 64 carbon atoms. The ring structure can include at least 80 carbon atoms. The ring structure can include at least 3 carbon-carbon double bonds. The ring structure can include at least 5 carbon-carbon double bonds. The ring structure can include at least 7 carbon-carbon double bonds. The ring structure can include at least 10 carbon-carbon double bonds. In another aspect, from about 60 to about 100% of the carbon-carbon bonds are in a trans configuration. From about 75 to about 85% of the double bonds can be in a trans configuration. In yet another aspect, a majority of the plurality of carbon-carbon double bonds are separated by one or more carbon-carbon single bonds. A majority of the plurality of carbon-carbon double bonds can be separated by from 4 to 12 carbon-carbon single bonds. The majority of the plurality of carbon-carbon double bonds of the ring structure can be separated by 5 to 11 carbon-carbon single bonds. A majority of the plurality of carbon-carbon double bonds can be separated by 6 to 10 carbon-carbon single bonds. Each of the plurality of carbon-carbon double bonds of the ring structure can be separated by 4 to 12 carbon-carbon single bonds. Each of the majority of carbon double-double bonds can be separated by 5 to 11 carbon-carbon single bonds. Each of the majority of carbon double-double bonds can be separated by 6 to 10 carbon-carbon single bonds. A majority of the plurality of carbon-carbon double bonds can occur every 8 carbon atoms. Individual bonds of the plurality of carbon-carbon double bonds can occur every 8 carbon atoms.

In another aspect, the macrocyclic polymer additive has a number average molecular weight of from about 50,000 g/mol to about 250,000 g/mol. The macrocyclic polymer additive can have a number average molecular weight of about 75,000 g/mol to about 225,000 g/mol. The macrocyclic polymer additive can have a number average molecular weight of about 100,000 g/mol to about 200,000g/mol. The macrocyclic polymer additive can have a number average molecular weight of about 125,000 g/mol to about 175,000 g/mol. In still another aspect, the macrocyclic polymer has a melting temperature less than 100 degrees Celsius. The macrocyclic polymer additive can have a melting temperature of less than 90 degrees Celsius. The macrocyclic polymer additive can have a melting temperature of less than 80 degrees Celsius. The macrocyclic polymer additive can have a melting temperature of less than 70 degrees Celsius. The macrocyclic polymer additive can have a melting temperature of less than 60 degrees Celsius. The macrocyclic polymer additive can have a melting temperature of from about 20 degrees Celsius to about 100 degrees Celsius. The macrocyclic polymer additive can have a melting temperature of from about 30 degrees Celsius to about 90 degrees Celsius. The macrocyclic polymer additive can have a melting temperature of from about 40 degrees Celsius to about 80 degrees Celsius. The macrocyclic polymer additive can have a melting temperature of or from about 50 degrees Celsius to about 70 degrees Celsius.

In an aspect, in the rubber composition, the macrocyclic polymer comprises a trans-polyoctenamer (TOR). An example of a TOR is a VESTENAMER additive, such as VESTENAMER 8012 from Evonik Industries AG, Germany.

In any of these aspects, the various benefits described above to the rubber composition, to the method of making the rubber composition, to the cured rubber articles comprising the cured reaction product of the rubber composition, and to methods of making the cured rubber articles can be attributed to the presence of and use of the macrocyclic polymer additive. In an aspect, use of the macrocyclic polymer additive improves mixing of the rubber composition. The use of the macrocyclic polymer additive can shorten mixing time of the rubber composition. The use of the macrocyclic polymer additive can reduce the maximum temperature to which the rubber composition is exposed during mixing. The use of the macrocyclic polymer additive can both reduce mixing time and reduce the maximum temperature to which the rubber composition is exposed during mixing. Use of the macrocyclic polymer additive can reduce the amount of residual compounds extracted from ground cured rubber when mixing the rubber compositions. Use of the macrocyclic polymer additive can reduce or prevent scorching or premature crosslinking in a rubber composition comprising ground cured rubber. In another aspect, the macrocyclic polymer additive is used to coat particles of ground cured rubber before incorporating the ground cured rubber into a rubber composition. The macrocyclic polymer additive can be combined directly with the ground cured rubber and the uncured rubber component of the rubber composition. The macrocyclic polymer additive can be combined directly with the ground cured rubber, uncured rubber component, and the curing package of the rubber composition. In a further aspect, and without wishing to be bound by theory, during mixing or storage, one or more double bonds in the ring structure of the macrocyclic polymer can be crosslinked to a surface of particles of the ground cured rubber to create surface-modified ground cured rubber particles. In one aspect, the macrocyclic polymer crosslinked to the ground cured rubber particles of the surface-modified ground cured rubber particles retain some unreacted double bonds, and at least a portion of the unreacted double bonds of the macrocyclic polymer crosslink with the uncured rubber component of the rubber composition during the curing step. In a further aspect, the rubber compositions comprise at least 1 phr of the macrocyclic polymer additive, which is a larger amount of the macrocyclic polymer additive than has been used previously in rubber composition comprising ground cured rubber and an uncured rubber component.

Various types of uncured rubber can be included in the uncured rubber component of the rubber composition. Although it is common in rubber compounding to use a combination of different types of rubber in a rubber composition (i.e., such that the uncured rubber component comprises or consists of two or more types of uncured rubber, or the uncured rubber component comprises or consists of three or more types of uncured rubber), the rubber component of the rubber composition can also comprise or consist of a single type of uncured rubber. In one aspect, in the rubber composition, the uncured rubber component can include a natural rubber, a synthetic rubber, or any combination thereof. Examples of synthetic rubbers include without limitation, synthetic polyisoprenes, polybutadienes, acrylonitrile buta-diene rubber, styrene acrylonitrile butadiene rubber, poly-chloroprene rubber, styrene-butadiene copolymer rubber, isoprene isobutylene copolymer rubber and its halogenated derivatives, ethylene-propylene-diene copolymer rubbers such as ethylene-propylene-cyclopentadiene terpolymer, ethylene-propylene-5-ethylidene-norbornene terpolymer, ethylene-propylene-1,4-hexadiene terpolymer, butadiene-propylene copolymer rubber, butadiene-ethylene copolymer rubber, butadiene-isoprene copolymer, polypentenamer, and millable urethanes and their mixtures. In one aspect, such compounds are characterized by repeating olefinic unsaturation in the backbone of the polymer, which may arise, for example, from the presence of butadiene or isoprene monomers in the polymer structure.

In a further aspect, the uncured rubber component comprises butyl rubber, styrene-butadiene rubber (SBR), isoprene rubber, chloroprene rubber, ethylene propylene diene monomer (EPDM) rubber, neoprene rubber, butadiene rubber, nitrile rubber, natural rubber, or any combination thereof. The uncured rubber component can comprise butyl rubber, isoprene rubber, and nitrile rubber. The uncured rubber component can comprise butyl rubber.

Various different particle sizes of ground cured rubber can be used. It has been found that, when at least 1 phr of the macrocyclic polymer additive are used in rubber compositions comprising an uncured rubber component in addition to ground cured rubber, it is not necessary to use ground cured rubber having relatively small particle sizes, as including at least 1 phr of the macrocyclic polymer additive results in rubber compositions which cure to rubber articles having good physical properties. In a still further aspect, in the rubber composition, the average particle size of the ground cured rubber is greater than 200 mesh, meaning that a particle of the average size is too large to fit through the openings of a 200 mesh per linear inch screen. The particle size of the ground cured rubber can be from about 10 mesh to about 175 mesh, meaning that all the particles of the ground cured rubber will fit through a 10 mesh screen but not through a 175 mesh screen. The particle size of the ground cured rubber can be from about 20 mesh to about 150 mesh. The particle size of the ground cured rubber can be from about 25 mesh to about 125 mesh. The particle size the ground cured rubber can be from about 25 mesh to about 100 mesh. The particle size of the ground cured rubber can be from about 25 mesh to about 75 mesh. The particle size of the ground cured rubber can be from about 25 mesh to about 50 mesh. The particle size of the ground cured rubber can be from about 25 to about 40 mesh.

Ground cured rubber from various sources can be used. In another aspect, in the rubber composition, the ground cured rubber comprises or consists of ground recycled cured rubber. The recycled rubber can comprise or consist of recycled footwear rubber. The recycled footwear rubber can comprise or consist of recycled cured rubber from a post-consumer article of footwear. The recycled footwear rubber can comprise or consist of cured rubber from a rejected article of footwear or rejected component of an article of footwear, waste cured rubber from production of an article of footwear or component of an article of footwear, or any combination thereof. The ground cured rubber can be ground tire rubber. Alternatively, ground cured rubbers other than ground tire rubber can be used, for example, in order to reduce the concentration of carbon black present, or to avoid the presence of byproducts of 2-mercaptobenzothiazole. In one aspect, in the rubber composition, the ground cured rubber comprises less than 5 phr carbon black. The ground cured rubber can be essentially free of byproducts of 2-mercaptobenzothiazole. In one aspect, the ground cured rubber is about 95 percent free of byproducts of 2-mercaptobenzothiazole. In another aspect, the ground cured rubber is about 98 percent free of byproducts of 2-mercaptobenzothiazole. In another aspect, the ground cured rubber is about 99 percent free of byproducts of 2-mercaptobenzothiazole. In another aspect, the ground cured rubber is about 99.9 percent free of byproducts of 2-mercaptobenzothiazole. The ground cured rubber can comprises less than 5 phr carbon black and be essentially free of byproducts of 2-mercaptobenzothiazole. In another aspect, the ground cured rubber is essentially free of ground tire rubber. In one aspect, the ground cured rubber is about 95 percent free of ground tire rubber. In one aspect, the ground cured rubber is about 98 percent free of ground tire rubber. In one aspect, the ground cured rubber is about 99 percent free of ground tire rubber. In one aspect, the ground cured rubber is about 99.9 percent free of ground tire rubber. In a further aspect, however, black recycled rubber from footwear or footwear production may be used which contains a small amount of carbon black, such as, for example, less than 5 phr when incorporated into the disclosed compositions, and can be used in the rubber compositions.

The rubber compositions disclosed herein comprise at least 5 phr ground cured rubber. While one advantage of the disclosed rubber compositions is that relatively large amounts of ground cured rubber can be included in them, the improvements in mixing of the rubber compositions can be obtained with relatively small amounts of ground cured rubber as well. In an aspect, the rubber composition comprises from about 5 phr to about 40 phr ground cured rubber. The rubber composition can comprise from about 10 phr to about 40 phr ground cured rubber. The rubber composition can comprise from about 10 phr to about 35 phr ground cured rubber. The rubber composition an comprise from about 10 phr to about 30 phr ground cured rubber.

In another aspect, the rubber composition further comprises from about 0.5 phr to about 5 phr of a process oil. Optionally the process oil comprises an oil from a non-petroleum source. The non-petroleum oil can be of plant or animal origin. Plant derived oils are often referred to as vegetable oils. The chemical structure of the non-petroleum oil can contain fatty acid side chains. When the structure of the oil includes fatty acid side chains, at least 50% of the fatty acid side chains have one or more sites of unsaturation. At least 67% of the fatty acid side chains of the oils can have one or more sites of unsaturation. The process oil can comprise or consist of a vegetable oil. The process oil can comprise or consist of soybean oil.

In another aspect, the rubber composition further comprises an additive. The additive can be chosen from a curing activator, a processing aid, an anti-oxidant, a wax, a homogenizer, a filler, a colorant, or any combination thereof. The additive can be a curing activator. The additive can be a processing aid. The additive can be an anti-oxidant. The additive a be a wax. The additive can be a homogenizer. The additive can be a filler other than ground cured rubber. The additive can be a colorant, such as a pigment.

The rubber composition can comprise a curing activator, or a compound which forms a curing activator in combination with another compound present in the rubber composition. Divalent metal oxides such as zinc oxide (ZnO), as well as CaO and MgO, are commonly referred to as curing activators when included in rubber compounds containing curing accelerators, particularly when the curing agent includes. It is believed that one molecule of a divalent metal oxide which includes a cationic component (e.g., ZnO) combines with two molecules of a fatty acid such as stearic acid (C₁₇H₃₅COOH) to form a salt or soap such as zinc stearate (Zn(C₁₇H₃₅COO)₂) and water. The soap (e.g., the zinc stearate) is believed to act as the curing activator. The rubber composition can comprise from about 0 phr to about 6 phr of the curing activator. The rubber composition can comprise from about 0.2 phr to about 5 phr of the curing activator. The rubber composition can comprise from about 0.5 phr to about 4 phr of the curing activator.

The curing activator of the rubber composition can comprise or consist of zinc oxide. In one aspect, the rubber composition comprises from about 1 phr to about 10 phr of zinc oxide. The rubber composition can comprise from about 2 phr to about 10 phr of zinc oxide. The rubber composition can comprise from about 5 phr to about 10 phr of the zinc oxide.

The rubber composition can comprise a processing aid. The processing aid can comprise or consist of polyethylene glycol. The processing aid can comprise or consist of stearic acid. The processing aid can comprise or consist of a combination of polyethylene glycol and stearic acid. The rubber composition can comprise from about 0 phr to about 6 phr of the processing aid. The rubber composition can comprise from about 0.2 phr to about 5 phr of the processing aid. The rubber composition can comprise from about 0.5 phr to about 4 phr of the processing aid. The rubber composition can comprise from about 0 phr to about 6 phr of polyethylene glycol. The rubber composition can comprise from about 0.2 phr to about 5 phr of polyethylene glycol. The rubber composition can comprise from about 0.5 phr to about 4 phr of polyethylene glycol. In a still further aspect, the rubber composition comprises from about 0 phr to about 6 phr stearic acid. The rubber composition can comprise from about 0.2 phr to about 5 phr stearic acid. The rubber composition can comprise from about 0.5 phr to about 4 phr of stearic acid.

The rubber composition can comprise an antioxidant. In one aspect, the antioxidant comprises a cresol derivative. The rubber composition can comprise from about 0 phr to about 6 phr of the antioxidant. The rubber composition can comprise from about 0.2 phr to about 5 phr of the antioxidant. The rubber composition can comprise from about 0.5 phr to about 4 phr of the antioxidant.

The rubber composition can comprise a wax. In one aspect, the wax comprises an anti-ozone wax. The rubber composition can comprise from about 0 phr to about 6 phr of the wax. The rubber composition can comprise from about 0.2 phr to about 5 phr of the wax. The rubber composition can comprise from about 0.5 phr to about 4 phr of the wax.

The rubber composition can comprise a homogenizer. In an aspect, the homogenizer comprises a hydrocarbon or hydrocarbon derivative. The rubber composition can comprise from about 0 phr to about 6 phr of the homogenizer. The rubber composition can comprise from about 0.2 phr to about 5 phr of the homogenizer. The rubber composition can comprise from about 0.5 phr to about 4 phr of the homogenizer.

The rubber compositions generally contain fillers, including reinforcing fillers. Examples of reinforcing fillers include silica, carbon black, clay, inorganic metal powder, mineral powder, talc, calcium sulfate, calcium silicate, and the like. It is understood that ground cured rubber is not considered a reinforcing filler. The reinforcing filler of the rubber composition can comprise or consist of silica. In one aspect, the reinforcing filler comprises or consists of precipitated silica. The rubber composition comprises from about 10 phr to about 75 phr reinforcing filler. The rubber composition can comprise from about 20 phr to about 65 phr of the reinforcing filler. The rubber composition can comprise from about 30 phr to about 55 phr of the reinforcing filler.

The rubber composition can comprise a colorant. In an aspect, the colorant comprises at least one pigment. Depending upon the type and amount of pigment used, the pigment may act as both a colorant and a reinforcing filler. The colorant can comprise less than 5 phr carbon black. The colorant can comprise less than 1 phr carbon black. The colorant can be substantially free of carbon black. The rubber composition can comprises from about 0 phr to about 5 phr of the colorant. The rubber composition can comprise about 0 phr to about 3 phr of the colorant. The rubber composition can comprise from about 0 phr to about 2 phr of the pigment.

The rubber compositions disclosed herein comprise a curing package comprising a curing agent and optionally comprising a curing accelerator. Conventional sulfur-based curing agents may be used in the rubber compositions described herein. Such curing agents are well known in the art and include elemental sulfur as well as a variety of organic sulfide, disulfide and polysulfide compounds. Examples include, without limitation, curing agents (also referred to as vulcanizing agents) such as morpholine disulfide, 2-(4′-morpholin-odithio) benzothiazole, and thiuram compounds such as tetramethylthiuram disulfide, tetraethylthiuram disulfide and 5-dipentamethylenethiuram tetrasulfide. The curing agents may be used alone or in combination with each other. In a preferred embodiment, sulfur is used as the curing agent.

Optionally, the rubber compositions can comprise one or more curing accelerators. The curing accelerator can be a non-polar curing accelerator. Curing accelerators and co-accelerators are known in the art and include without limitation, those based on dithiocarbamate, thiazole, amines, guanidines, xanthates, thioureas, thiurams, dithiophosphates, and sulfenamides. Non-limiting examples of accelerators include: zinc diisobutyldithiocarbamate, zinc salt of 2-mercaptobenzothiazole, hexamethylenetetramine, 1,3-diphenyl guani-dine, zinc isopropyl xanthate, trimethylthiourea, tetrabenzyl thiuram disulfide, zinc O,O-di-n-butylphosphorodithioate, and N-t-butyl-2-benzothiazylsulfenamide.

It may be desired to provide rubber compositions that cure and can be processed with a minimum of emissions of potentially harmful by products. In some embodiments, it is preferred to use accelerators and co-accelerators that generate nitrosamines known to be non-carcinogenic. One such accelerator is tetrabenzylthiuram disulfide. It is known to generate a nitrosamine, N-nitrosodibenzylamine, which is not carcinogenic according to published literature. A preferred co-accelerator is MBTS or 2,2′-dithiobisbenzothiaz-ole.

The rubber compositions disclosed here in can from about 0.2 phr to about 10 phr of the curing package. The rubber composition can comprise from about 0.5 phr to about 7 phr of the curing package. The rubber composition can comprise from about 1 phr to about 5 phr of the curing package. The rubber composition can comprise from about 1 phr to about 5 phr of sulfur. The rubber composition can comprise from about 0 phr to about 10 of curing accelerator. The rubber composition can comprise from about 0.5 phr to about 7 phr of the curing accelerator. The rubber composition can comprise from about 1 to about phr of the curing accelerator.

### METHOD OF MAKING THE RUBBER COMPOSITION

In one aspect, disclosed herein is method for making a rubber composition, the method comprising: (a) admixing an uncured rubber component, ground cured rubber, and a macrocyclic polymer additive to form a polymeric component of a rubber composition, optionally wherein the admixing comprises coating the ground cured rubber with the macrocyclic polymer additive prior to combining the coated ground rubber with the uncured rubber component; (b) combining a curing package with the polymeric component to make the rubber composition; and (c) optionally adding at least one additional component to the rubber composition; wherein the polymeric component comprises or consists of 100 parts of an uncured rubber component comprising at least one uncured rubber, at least 5 parts per hundred rubber (phr) ground cured rubber, and at least 1 phr of a macrocyclic polymer additive comprising a macrocyclic polymer; and wherein the curing package comprises sulfur and optionally a curing accelerator.

In a further aspect, the method comprises (a) admixing the polymeric component prior to (b) combining the curing package with the admixed polymer component; storing the admixed polymeric component for at least 1 day prior to (b) combining the curing package with the stored admixed polymer component. In some aspects, (a) admixing the polymeric component and (b) combining the curing package with the polymeric component are conducted simultaneously.

In one aspect, “admixing” as used herein can comprise calendaring the rubber composition, pressing the rubber composition, or both.

In one aspect, the method further comprises storing one or more portions of the rubber composition for at least 3 days; and includes (c) adding the at least one additional component to a stored rubber composition. In another aspect, the storing comprises storing the one or more portions of the rubber composition for at least 5 days, at least 7 days, or at least 9 days.

In an aspect, the TS2 of a portion of the rubber composition stored for at least 5 days is less than or equal to the TS2 of a portion of the rubber composition stored for 3 days; optionally the TS2 of the portion of the rubber composition stored for at least 7 days is less than or equal to the TS2 of the portion of the rubber composition stored for 3 days; optionally wherein the TS2 of the portion of the rubber composition stored for at least 9 days is less than or equal to the TS2 of the portion of the rubber composition stored for 3 days. In another aspect, the T90 of a portion of the rubber composition stored for at least 5 days is less than or equal to the T90 of a portion of the rubber composition stored for 3 days; optionally the T90 of the portion of the rubber composition stored for at least 7 days is less than or equal to the T90 of the portion of the rubber composition stored for 3 days; or the T90 of the portion of the rubber composition stored for at least 9 days is less than or equal to the T90 of the portion of the rubber composition stored for 3 days.

In any of these aspects, the rubber composition can be processed on existing equipment useful for processing rubber (e.g. Banbury and/or overhead mixers) without modifying the equipment.

In one aspect, the rubber composition comprises a rubber composition as described above, or comprises a rubber composition made by the method described above.

### CURED ARTICLE COMPRISING VULCANIZED RUBBER COMPOSITION

In one aspect, disclosed herein is a cured rubber article comprising the vulcanized product of a rubber composition including a polymeric component, and a curing package comprising sulfur and optionally a curing accelerator; wherein the polymeric component comprises or consists of 100 parts of an uncured rubber component comprising at least one uncured rubber, ground cured rubber, and a macrocyclic polymer additive comprising a macrocyclic polymer. In another aspect, the rubber composition comprises at least 1 phr of the macrocyclic polymer additive. In another aspect, the rubber composition comprises at least 1 phr of the macrocyclic polymer additive and at least 5 phr of the ground rubber. In yet another aspect, the rubber composition is or comprises a rubber composition as described above.

In a further aspect, the cured rubber article is a component of an article of footwear, apparel or sporting equipment, such as, for example, an outsole for an article of footwear.

### METHOD FOR MAKING A CURED RUBBER ARTICLE

In an aspect, disclosed herein is a method for making a cured rubber article, the method comprising placing a rubber composition in a mold, wherein the rubber composition comprises 100 parts of an uncured rubber component comprising at least one uncured rubber; ground cured rubber, a macrocyclic polymer additive, a curing package comprising sulfur and optionally a curing accelerator. and optionally at least one additional component; exposing the rubber composition in the mold to vulcanizing conditions for a sufficient period of time to substantially vulcanize the rubber composition, forming the cured rubber article; and removing the cured rubber article from the mold. In another aspect, the rubber composition comprises at least 1 phr of the macrocyclic polymer additive. In yet another aspect, the rubber compositions comprises at least 5 phr of the ground rubber and at least 1 phr of the macrocyclic polymer additive.

The compositions may be processed and cured by placing the compositions into a heated mold. The mold is placed into a press and held for a specified period of time at a temperature sufficient to achieve cure (vulcanization). Typically, the curing time is obtained from a rheometer curve, such as conventional in the rubber processing industry. For example, the moldable rubber compositions may be cured for a time equal to T90 plus one minute, where T90 is the time required for 90% of the viscosity to develop. Typical temperatures are generally from about 145 to 165 degrees Celsius, and typical times can range from 3-9 minutes, though processing outside these times and temperature ranges is also possible, especially in large parts with thick cross sections.

In another aspect, the curing (vulcanizing) conditions comprise increasing the temperature of the rubber composition in the mold to a temperature of from about 140 degrees Celsius to about 170 degrees Celsius. The curing conditions can comprise increasing the temperature of the rubber composition in the mold to a curing temperature of from about 150 degrees Celsius to about 160 degrees Celsius. The curing conditions can comprise increasing the temperature to a curing temperature of at least 160 degrees Celsius. The curing conditions can comprise increasing the temperature to a curing temperature of at least 150 degrees Celsius. The curing can include exposing the rubber composition in the mold to the curing temperature for at least 200 seconds. The curing can include exposing the rubber composition in the mold to the during temperature for at least 250 seconds. In yet another aspect, the curing conditions comprise increasing the temperature of the rubber composition in the mold to a curing temperature of about 155 degrees Celsius for about 300 seconds.

In one aspect, the rubber composition is a rubber composition as described above, or is made according to the method described above. In another aspect, the cured rubber article is a cured rubber article as described above. In a further aspect, the cured rubber article is a component of an article of footwear, apparel or sporting equipment, such as, for example, an outsole for an article of footwear.

### PROPERTIES OF THE CURED RUBBER ARTICLE

The cured rubber article can have a hardness of from about 64 to about 70 Shore A as measured by ASTM 2240-97. The cured rubber article can have a tensile strength of greater than 100 kilograms per square centimeter as measured by ASTM D 638. The cured rubber article can have an elongation of greater than about 550% as measured by ASTM D 638. The cured rubber article can have an elongation of from about 550% to about 700% as measured by ASTM D 638. The cured rubber article can have a 300% modulus of greater than or equal to 35 kilograms per square centimeter as measured by ASTM D 638. The cured rubber article can have a tear strength of greater than about 35 kilograms per centimeter as measured by ASTM D 624. The cured rubber article can have a DIN abrasion resistance index of less than 0.52 as measured by ASTM D 1053.

### EXEMPLARY ASPECTS OF ARTICLES OF FOOTWEAR, ARTICLES OF APPAREL, AND ARTICLES OF SPORTING EQUIPMENT

FIGS. 1A-1M illustrate footwear, apparel, athletic equipment, containers, electronic equipment, and vision wear that include the structure (e.g., the foamed article) of the present disclosure. In an aspect, when the article is an article of footwear, such as shown in FIGS. 1A-1B, cured rubber can be used as a component such as an outsole or part of an outsole, including a cleat or other protrusion from the ground-facing surface of the outsole, or in another area where protection such as water resistance or abrasion resistance is desired. In one aspect, when the article is an article of apparel, such as depicted in FIGS. 1C, 1D, 1E, 1F, 1G, and 1K, cured rubber can be used as a component including, but not limited to, a closure or a region that provides protection such as, for example, water resistance or abrasion resistance. Similarly, when the article is a container such as a backpack seen in FIG. 1J. the cured rubber can be used as a closure, can be used to provide water resistance or abrasion resistance, or the like. In another aspect, when the article is an article of athletic equipment, such as the soccer ball or football depicted in FIG. 1I, cured rubber can be used as an inner lining to prevent loss of internal gas or in an inlet for filling the ball. In other articles of athletic equipment such as the baseball glove of FIG. 1H, cured rubber can be used as a closure, as part of an inner surface to provide grip to the wearer's hand, or for water or abrasion resistance. In an aspect, in the watch of FIG. 1L, all of the watchband or portions of the watchband can comprise cured rubber. In one aspect, all or portions of the frames of the eyeglasses or sunglasses depicted in FIG. 1M can comprise cured rubber as disclosed herein.

FIGS. 1N(a)-1N(b) illustrate a perspective view and a side view of an article of footwear 100 that include a sole structure 104 and an upper 102. The sole structure 104 is secured to the upper 102 and extends between the foot and the ground when the article of footwear 100 is worn. The primary elements of the sole structure 104 are a midsole 114 and an outsole 112. The midsole 114 is secured to a lower area of the upper 102 and can be formed of a polymer foam or another appropriate material. In other configurations, the midsole 114 can incorporate fluid-filled chambers, plates, moderators, and/or other elements that further attenuate forces, enhance stability, or influence motions of the foot. In the example illustrated in FIGS. 1N(a)-1N(b), the sole structure 104 includes an outsole 112 which is secured to a lower surface of the midsole 114, where the outsole 112 is a cured rubber article as described herein. Alternatively, the sole structure is or includes a cured rubber article as described herein, such as a cup sole, and is secured directly to the upper 102 in the article of footwear 100. In either embodiment, outsole 112 can be textured to impart traction, for example. The upper 102 can be formed from various elements (e.g., lace, tongue, collar) that combine to provide a structure for securely and comfortably receiving a foot. Although the configuration of the upper 102 can vary significantly, the various elements generally define a void within the upper 102 for receiving and securing the foot relative to sole structure 104. Surfaces of the void within upper 102 are shaped to accommodate the foot and can extend over the instep and toe areas of the foot, along the medial and lateral sides of the foot, under the foot, and around the heel area of the foot. The upper 102 can be made of one or more materials such as textiles, a polymer foam, leather, synthetic leather, and the like that are stitched or bonded together. Although this configuration for the sole structure 104 and the upper 102 provides an example of a sole structure that can be used in connection with an upper, a variety of other conventional or nonconventional configurations for the sole structure 104 and/or the upper 102 can also be utilized. Accordingly, the configuration and features of the sole structure 104 and/or the upper 102 can vary considerably. Additional components which can be cured rubber articles as described herein include toe bumpers, heel counters, foxing along a sidewall of the sole structure, abrasion-resistant panels of the upper, and the like.

### PROPERTY ANALYSIS AND CHARACTERIZATION PROCEDURES

Specific Gravity/Density Test Protocol. The specific gravity (S.G.) or density is measured for samples taken using the Material Sampling Procedure as described herein, using a digital balance or a Densicom Tester (Qualitest, Plantation, Florida, USA). Each sample is weighed and then is submerged in a distilled water bath (at 22 degrees Celsius plus or minus 2 degrees Celsius). To avoid errors, air bubbles on the surface of the samples are removed, e.g., by wiping isopropyl alcohol on the sample before immersing the sample in water, or using a brush after the sample is immersed. The weight of the sample in the distilled water is recorded. The specific gravity is calculated using the following formula (see also ASTM D-792):

$$S . G . = \frac{Weight of the sample in air ( g )}{Weight of sample in air ( g ) - Weight of sample in water ( g )}$$

Vulcanization Characteristics Test Protocol. The optimum cure time (T90) and scorch time (TS2) are measured using a Rubber Process Analyzer (RPA) from TA Instruments (New Castle, DE, USA). The RPA includes two cone-shaped dies in a chamber that can be enclosed and sealed. A sample is uncured rubber is placed on the lower die, the chamber is closed, and the sample is pressed between the two dies. Excess material is squeezed out of the chamber, ensuring a constant sample volume.

TS2 is calculated from torque values measured as the RPA chamber heats to cure the uncured rubber. TS2 is the time at which torque rises two units (typically 2 deciNewtons·meters) above the minimum measured torque value of the sample and is an indication of when the sample begins vulcanization.

T90 is calculated from torque values measured as the RPA chamber heats to cure the uncured rubber and represents the time necessary for the torque to attain 90% of its maximum achievable value.

TS2 and T90 tests were performed at 155 degrees Celsius±5 degrees Celsius for 300 seconds.

Shore A Hardness Test Protocol. The hardness of a material is determined according to the test protocol detailed in ASTM D-2240 Durometer Hardness, using a Shore A scale. The sample is prepared using the Material Sampling Procedure.

Tensile Strength Test Protocol. The tensile strength of a material is determined according to the test protocol detailed in ASTM D 638. The sample is prepared using the Material Sampling Procedure.

Elongation Test Protocol. The elongation of a material is determined according to the test protocol detailed in ASTM D 638. The sample is prepared using the Material Sampling Procedure.

300% Modulus Test Protocol. The 300% modulus of a material is determined according to the test protocol detailed in ASTM D 638. The sample is prepared using the Material Sampling Procedure.

Tear Strength Test Protocol. The tea strength of a material is determined according to the test protocol detailed in ASTM D 624. The sample is prepared using the Material Sampling Procedure.

DIN Abrasion Test Protocol. Samples are prepared according to the Material Sampling Procedure described below. Abrasion loss is tested on cylindrical samples with a diameter of 16±0.2 millimeters and a minimum thickness of 6 millimeters cut using a ASTM standard hole drill. The abrasion loss is measured using Method B of ASTM D 5963-97a on a Gotech GT-7012-D abrasion test machine. The tests are performed as 22 degrees Celsius with an abrasion path of 40 meters. The Standard Rubber #1 used in the tests has a density of 1.336 grams per cubic centimeter. The smaller the abrasion loss volume, the better the abrasion resistance. In some experiments, DIN Resistance Index was determined by the following equation:

$$DIN Resistance Index = \frac{( Mass Loss of Tested Rubber ) / ( Density of Tested Rubber )}{( Mass Loss of Standard Rubber ) / ( Density of Standard Rubber )} \times 100 \%$$

### SAMPLING PROCEDURES

Using the Test Protocols described above, various properties of the materials disclosed herein and articles formed therefrom can be characterized using samples prepared with the following sampling procedures.

Material Sampling Procedure. The Material Sampling Procedure can be used to obtain a neat sample of a cured rubber article. The sample can be cut from a plaque or a component or article containing the cured rubber, such as a composite element or a sole structure, thereby isolating a sample of the cured rubber. If the cured rubber is bonded to one or more additional materials, the procedure can include separating the additional materials from the cured rubber to be tested.

The sample is taken at a location along the article or component that provides a substantially constant thickness for the cured rubber as present on the article or component (within plus or minus 10 percent of the average thickness of the cured rubber). For many of the test protocols described above, a sample having a surface area of 4 square centimeters is used. The sample is cut into a size and shape (e.g., a dogbone-shaped sample) to fit into the testing apparatus. In cases where the cured rubber is not present on the article or component in any segment having a 4 square centimeter surface area and/or where its thickness is not substantially constant for a segment having a 4 square centimeter surface area, sample sizes with smaller cross-sectional surface areas can be taken and the area-specific measurements are adjusted accordingly.

### DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

All publications, patents, and patent applications cited in this specification are cited to disclose and describe the methods and/or materials in connection with which the publications are cited. All such publications, patents, and patent applications are herein incorporated by references as if each individual publication or patent were specifically and individually indicated to be incorporated by reference. Such incorporation by reference is expressly limited to the methods and/or materials described in the cited publications, patents, and patent applications and does not extend to any lexicographical definitions from the cited publications, patents, and patent applications. Any lexicographical definition in the publications, patents, and patent applications cited that is not also expressly repeated in the instant specification should not be treated as such and should not be read as defining any terms appearing in the accompanying claims.

This disclosure is not limited to particular aspects, embodiments, or examples described, and as such can, of course, vary. The terminology used herein serves the purpose of describing particular aspects, embodiments, and examples only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges can independently be included in the smaller ranges and are also encompassed within the disclosure, subject to any specifically excluded limit in the stated range. Where the stated range includes one or both of the limits, ranges excluding either or both of those included limits are also included in the disclosure.

As will be apparent to those of skill in the art upon reading this disclosure, each of the individual aspects, embodiments and examples described and illustrated herein has discrete components and features which can be readily separated from or combined with the features of any of the other several aspects, embodiments, and examples without departing from the scope or spirit of the present disclosure. Any recited method can be carried out in the order of events recited or in any other order that is logically possible.

Although any methods and materials similar or equivalent to those described herein can also be used in the practice or testing of the present disclosure, the preferred methods and materials are now described. Functions or constructions well-known in the art cannot be described in detail for brevity and/or clarity. Aspects of the present disclosure will employ, unless otherwise indicated, techniques of nanotechnology, organic chemistry, materials science and engineering and the like, which are within the skill of the art. Such techniques are explained fully in the literature.

It should be noted that ratios, concentrations, amounts, and other numerical data can be expressed herein in a range format. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and “greater than z”. In addition, the phrase “about ‘x’ to ‘y’”, where ‘x’ and ‘y’ are numerical values, includes “about ‘x’ to about ‘y’”. It is to be understodd that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1 percent to 5 percent” should be interpreted to include not only the explicitly recited values of about 0.1 percent to about 5 percent. but also include individual values (e.g., 1 percent, 2 percent. 3 percent, and 4 percent) and the sub-ranges (e.g., 0.5 percent, 1.1 percent, 2.4 percent, 3.2 percent, and 4.4 percent) within the indicated range.

As used herein, the term “polymer” refers to a chemical compound formed of a plurality of repeating structural units referred to as monomers. Polymers often are formed by a polymerization reaction in which the plurality of structural units become covalently bonded together. When the monomer units forming the polymer all have the same chemical structure, the polymer is a homopolymer. When the polymer includes two or more monomer units having different chemical structures, the polymer is a copolymer. One example of a type of copolymer is a terpolymer, which includes three different types of monomer units. The co-polymer can include two or more different monomers randomly distributed in the polymer (e.g., a random co-polymer). Alternatively, one or more blocks containing a plurality of a first type of monomer can be bonded to one or more blocks containing a plurality of a second type of monomer, forming a block copolymer. A single monomer unit can include one or more different chemical functional groups.

Polymers having repeating units which include two or more types of chemical functional groups can be referred to as having two or more segments. For example, a polymer having repeating units of the same chemical structure can be referred to as having repeating segments. Segments are commonly described as being relatively harder or softer based on their chemical structures, and it is common for polymers to include relatively harder segments and relatively softer segments bonded to each other in a single monomeric unit or in different monomeric units. When the polymer includes repeating segments, physical interactions or chemical bonds can be present within the segments or between the segments or both within and between the segments. Examples of segments often referred to as “hard segments” include segments including a urethane linkage, which can be formed from reacting an isocyanate with a polyol to form a polyurethane. Examples of segments often referred to as “soft segments” include segments including an alkoxy functional group, such as segments including ether or ester functional groups, and polyester segments. Segments can be referred to based on the name of the functional group present in the segment (e.g., a polyether segment, a polyester segment), as well as based on the name of the chemical structure which was reacted in order to form the segment (e.g., a polyol-derived segment, an isocyanate-derived segment). When referring to segments of a particular functional group or of a particular chemical structure from which the segment was derived, it is understood that the polymer can contain up to 10 mole percent of segments of other functional groups or derived from other chemical structures. For example, as used herein, a polyether segment is understood to include up to 10 mole percent of non-polyether segments.

The terms “Material Sampling Procedure” as used herein refers to the respective sampling procedures and test methodologies described in the Property Analysis and Characterization Procedure section. These sampling procedures and test methodologies characterize the properties of the recited materials, films, articles and components, and the like, and are not required to be performed as active steps in the claims.

The term “about,” as used herein, can include traditional rounding according to significant figures of the numerical value. In some aspects, the term about is used herein to mean a deviation of 10 percent, 5 percent, 2.5 percent, 1 percent, 0.5 percent, 0.1 percent, 0.01 percent, or less from the specified value.

The articles “a” and “an,” as used herein, mean one or more when applied to any feature in aspects of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and can have a singular or plural connotation depending upon the context in which it is used.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated±10 percent variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the phrase “consists essentially of” or “consisting essentially of” refer to the feature being disclosed as having primarily the listed feature without other active components (relative to the listed feature) and/or those that do not materially affect the characteristic(s) of the listed feature. For example, the rubber composition material can consist essentially of a ground cured rubber, an uncured rubber, and a macroscopic polymer, which means that rubber composition can include fillers, colorants, etc. that do not substantially interact with or interact with the change the function or chemical characteristics of the rubber composition. In another example, the uncured rubber can consist essentially of a butyl rubber, which means that the butyl rubber does not include a sufficient amount of another type of rubber compound to alter the properties (e.g., melting temperature, surface energy of the mixture, or the like) of the rubber composition. Further in this aspect, when the butyl rubber consists essentially of one polymer type, it may contain less than 1 weight percent of another type of polymer.

As used herein, the terms “at least one” and “one or more of” an element are used interchangeably, and have the same meaning that includes a single element and a plurality of the elements, and can also be represented by the suffix “(s)” at the end of the element. For example, “at least one butyl rubber”, “one or more butyl rubbers”, and “butyl rubber(s)” can be used interchangeably and have the same meaning.

As used herein, a “macrocyclic polymer” is a molecule containing a ring of twelve or more atoms. In an aspect, a plurality of, or all of the atoms of the ring, can be carbon atoms. In some aspects, a macrocyclic polymer can have at least 12, 24, 40, 60, or more than 80 atoms in the ring. In another aspect, carbon atoms in the ring can be linked by single or double bonds, wherein at least a portion of the double bonds are in the trans configuration.

“Parts per hundred rubber” (“phr”) as used herein refers to the parts by weight of a second component (e.g. macrocyclic polymer additive, process oil, or the like) in a rubber composition relative to uncured rubber in the composition. Thus, in a given composition, the parts of the uncured rubber component of the rubber formulation is set at 100.

“TS2” is a measurement of when a compound starts to vulcanize and is typically assessed using a rubber process analyzer, rheometer, or similar device. TS2 is measured in units of time and indicates time from the beginning of a vulcanization test to when the torque value applied to the sample increases to a set value such as, for example, 2 deciNewtons · meters above the lowest value of the torque curve. In one aspect, when TS2 (also sometimes referred to herein as “scorch” time) is too low, this may be an indication that too much curing package has been added to the rubber formulations, although other factors including applied heat, viscosity, and difficulty or ease of mixing may also contribute.

“T90” is a measurement of the time required for a cured rubber composition to achieve optimal properties and is typically assessed using a rubber process analyzer, rheometer, or similar device. T90 is measured in units of time and indicates time for torque on the cured rubber sample to reach 90% of maximum achievable torque.

As a person skilled in the art will readily appreciate, the above description is meant as an illustration of the implementation of the principles of the inventions. This description is not intended to limit the scope or application of the inventions in that the invention is susceptible to modification, variation, and change, without departing from the spirit of the inventions as defined in the following claims.

### EXAMPLES

The present disclosure is more particularly described in the following examples that are intended as illustrations only, since numerous modifications and variations within the scope of the present disclosure will be apparent to those skilled in the art.

### Example 1: Exemplary Rubber Compositions

Components of exemplary rubber compositions according to the present disclosure are presented in Table 1:

TABLE 1
Exemplary Rubber Compositions

| | | | | |
|---|---|---|---|---|
| Category of | | Broad | Mid- | Narrow |
| Component | Exemplary Component | Range (phr) | Range (phr) | Range (phr) |

Polymeric Ingredients

| | | | | |
|---|---|---|---|---|
| Uncured Rubber | | 50-100 | 60-100 | 70-100 |
| | Uncured Butadiene Rubber | 70-100 | 70-100 | 70-100 |
| | Uncured Isoprene Rubber | 0-20 | 1-15 | 5-10 |
| | Uncured Nitrile Rubber | 0-20 | 1-15 | 5-10 |
| Macrocyclic | Vestenamer | 1-20 | 5-15 | 6-10 |
| Polymer Additive | | | | |
| Ground | Ground Crosslinked Outsole | 5-50 | 7-40 | 10-35 |
| Crosslinked Rubber | Rubber, 25-40 Mesh | | | |

Non-Polymeric Ingredients

| | | | | |
|---|---|---|---|---|
| Zinc Oxide | | 1-10 | 2-10 | 5-10 |
| Processing Oil | | 1-10 | 1-7 | 1-5 |
| Processing Aid | PEG-based Processing Aid | 0-6 | 0.2-5 | 0.5-4 |
| | Stearic Acid-based Processing Aid | 0-6 | 0.2-5 | 0.5-4 |
| Anti-Oxidant | Cresol-based Anti-Oxidant | 0-6 | 0.2-5 | 0.5-4 |
| Anti-Ozone | Wax-based Anti-Ozone Additive | 0-6 | 0.2-5 | 0.5-4 |
| Additive | | | | |
| Homogenizer | Hydrocarbon resin-based | 0-6 | 0.2-5 | 0.5-4 |
| | Homogenizer | | | |
| Curing Activator | | 0-6 | 0.2-5 | 0.5-4 |
| or Promoter | | | | |
| Filler | Precipitated Silica Filler | 10-75 | 20-65 | 30-55 |

Curing Package

| Vulcanizing | Sulfur-based Vulcanizing Agent | 0.2-10 | 0.5-7 | 1-5 |
|---|---|---|---|---|
| Agent | Sulfur-based Vulcanizing Agent with Polymeric Binder | | | |
| Vulcanization | Non-polar Vulcanization Accelerator | 0-10 | 0.5-7 | 1-5 |
| Accelerator | | | | |

Coloring Package

| | | | | |
|---|---|---|---|---|
| Coloring Agent | One or more Coloring Agents | 0-5 | 0-3 | 0-2 |

Exemplary compositions included 70 to 90 or 75 to 85 phr of uncured butadiene rubber with 5 to 15 phr or 7 to 10 phr each of both uncured natural rubber and uncured isoprene rubber.

Exemplary formulations for testing properties of cured rubber articles according to the present disclosure are provided in Table 2:

TABLE 2
Test Formulation

| | | |
|---|---|---|
| Ingredient | phr | Vendor |

Polymeric Ingredients

| Virgin Rubbers | Description | | |
|---|---|---|---|
| BR 150 | Virgin Butadiene Rubber | 85.00 | UBE |
| IR2200 | Virgin Isoprene Rubber | 7.50 | Zeon |
| NT-3965F | Virgin Nitrile Rubber | 7.50 | Lanxess |
| Total | | 100.00 | |
| Vestenamer | Macrocyclic polymer additive | 3, 6 or | Evonik |
| | | 9* | |
| Ground Cured | Ground Crosslinked Outsole Rubber, | 0, 11 | Proprietary |
| Rubber | 25-40 Mesh | or 33 | |

Non-Polymeric Ingredients

| | | | |
|---|---|---|---|
| ZnO-80 | Zinc Oxide, 80% active content | 5.80 | ATMAN |
| Soy Bean Oil | Processing Oil (non-petroleum based) | 1.00 | Commodity |
| PEG-4000 | Processing Aid (Polyethlyene Glycol) | 3.02 | Buwon |
| ST/A | Processing Aid (Steric Acid) | 1.01 | PT.ASUMI |
| | | | ASIH |
| Kumanox 5010L | Anti-Oxidant (Cresol Derivative) | 0.50 | KUMHO |
| 1956/S683 | Anti-Ozone Wax | 0.50 | Okerin/ Sasol |
| | | | Gmbh |
| R60 | Homogenizer (hydrocarbon resin-based) | 3.02 | ATMAN |
| 1987A | Curing Activator/Promoter | 1.19 | RHEINCHEMIE |
| ZQ 356K | Filler (Precipitated Silica) | 52.91 | Zheng Sheng |

Curing Package

| | | | |
|---|---|---|---|
| SAT150 | Vulcanizing Agent (76% Sulfur content) | 2.96 | ATMAN |
| TBZTD | Vulcanizing Agent (80% Sulfur content | 0.15 | Atman |
| | with polymeric binder) | | |
| AS100 | Vulcanization Accelerator (non-polar | 0.84 | Robac |
| | accelerator) | | |

Coloring Package

| | | | |
|---|---|---|---|
| BR 8060 | Coloring Agent | 0.37 | Janie Color |

*For some experiments, amount of macrocyclic polymer additive was varied as indicated, while other components were held constant.

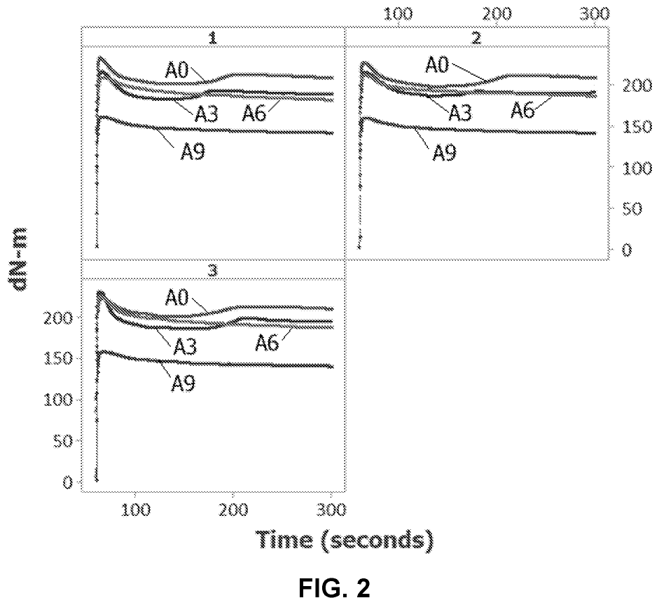

A key to the rubber compositions for which test results are displayed in FIGS. 2A-9 is found in Table 3. Any component not listed in Table 3 was held at the value shown in Table 2 for testing purposes.

TABLE 3
Key to Test Rubber Compositions

| | phr Macrocyclic | phr Ground |
|---|---|---|
| Code | Polymer Additive | Rubber |
| A0 | 0 | 0 |
| A3 | 3 | 0 |
| A6 | 6 | 0 |
| A9 | 9 | 0 |
| A0-11 | 0 | 11 |
| A3-11 | 3 | 11 |
| A6-11 | 6 | 11 |
| A9-11 | 9 | 11 |
| A0-33 | 0 | 33 |
| A3-33 | 3 | 33 |
| A6-33 | 6 | 33 |
| A9-33 | 9 | 33 |

### Example 2: Properties of Rubber Compositions

Mooney Viscosity: The macrocyclic polymer additive has a Mooney Viscosity at 100 degrees Celsius of less than 10 dN.m. Increasing the amount of macrocyclic polymer additive results in a reduced Mooney Viscosity (see FIG. 2). At 9 phr macrocyclic polymer additive, Mooney Viscosity of the rubber compositions drops dramatically.

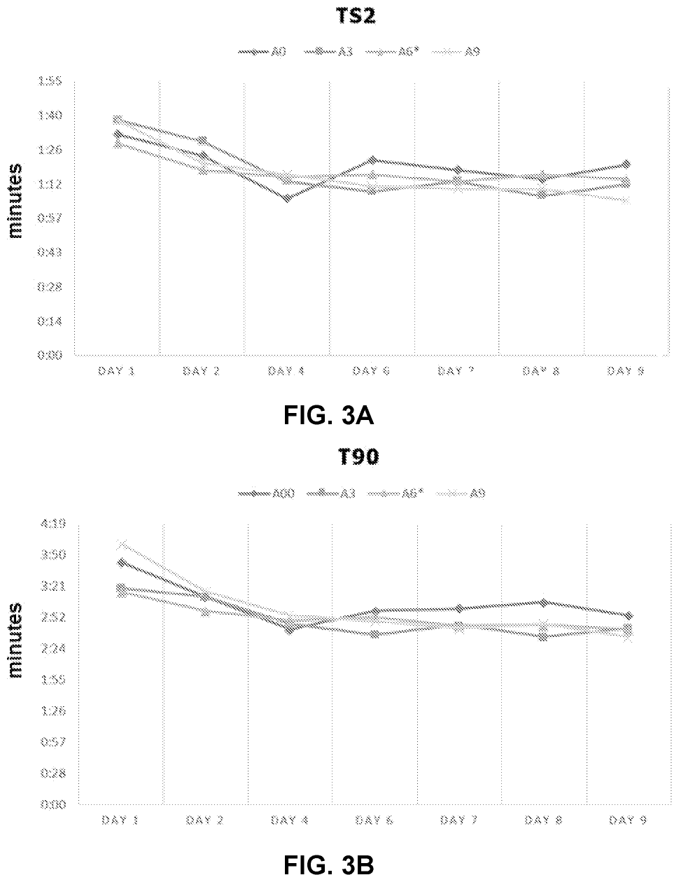

Rheology: The effect of the macrocyclic polymer additive on rheology of the rubber compositions is not noticeable with respect to TS2. However, T90 of Day 1 shows a significant delay at 9 phr macrocyclic polymer additive. Without wishing to be bound by theory, the macrocyclic polymer additive, as a short chain polymer, may affect relaxation of the composition (see FIGS. 3A-3B).

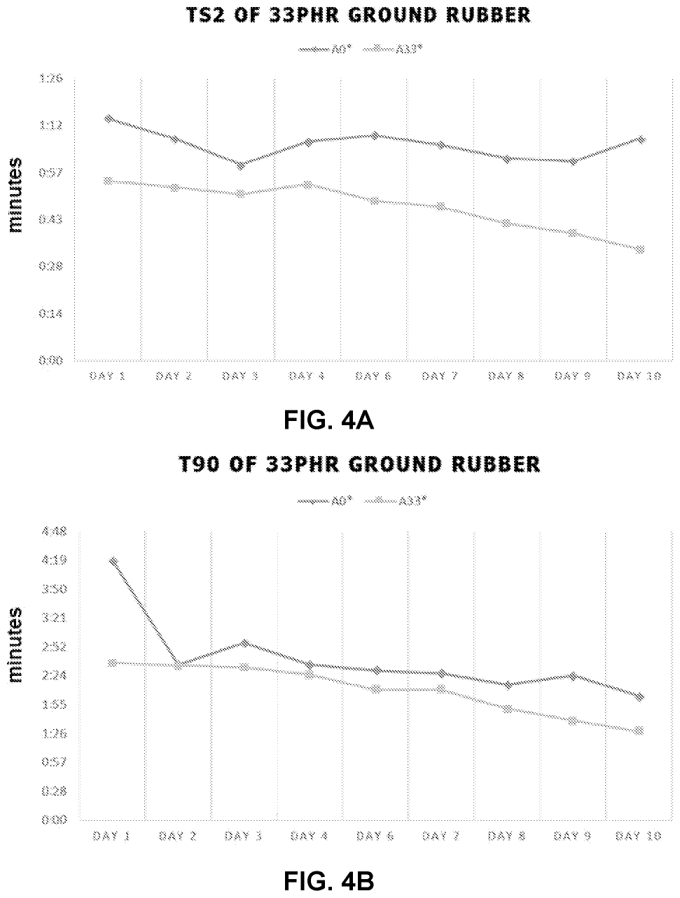

With the addition of ground rubber, rheology of the rubber compositions is shortened; this is known as scorching, or a premature reaction that causes partial vulcanization of rubber. Without wishing to be bound by theory, curatives in the ground rubber may have migrated to the surface of the rubber particles, influencing scorching behavior (see FIGS. 4A-4B).

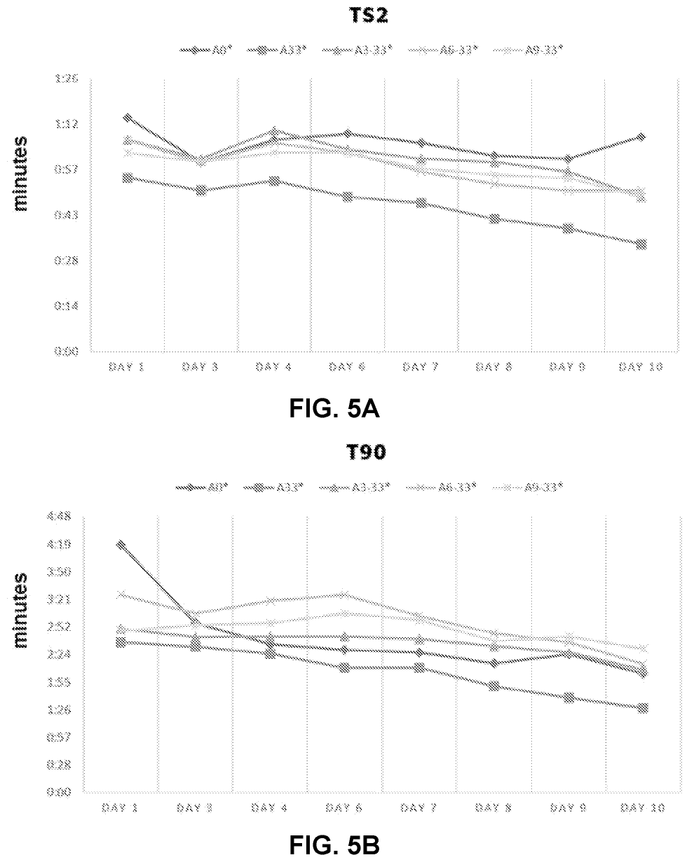

Compositions including both macrocyclic polymer additive and ground rubber show prolonged rheology. Without wishing to be bound by theory, the macrocyclic polymer additive is unsaturated and may be reactive towards curatives. In other words, the macrocyclic polymer additive provides a masking layer on ground rubber surfaces, absorbing curatives that migrate from the interior of the ground rubber particles during processing (see FIGS. 5A-5B).

Rubber compounds can be stored longer with reduced scorching, as evidenced by the rheology tests on compositions containing both macrocyclic polymer additive and ground cured rubber.

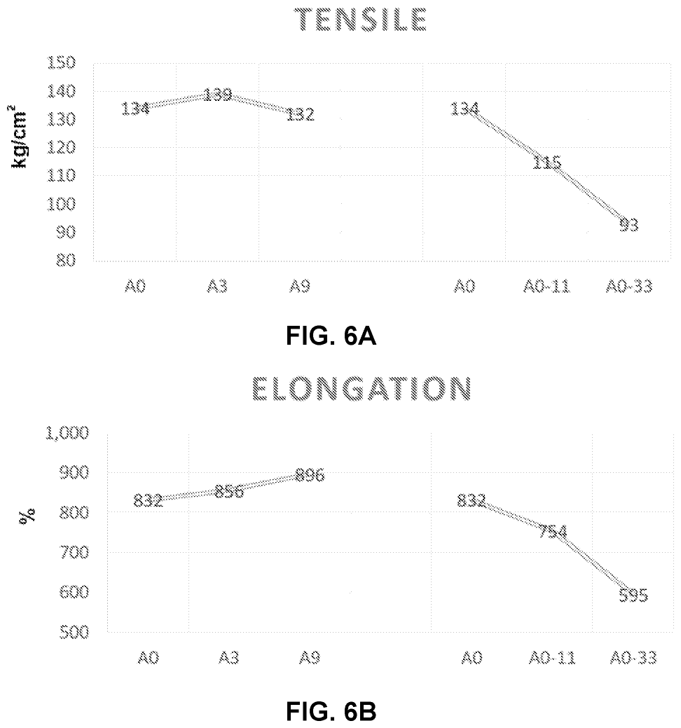

Physical Performance: The presence of ground rubber has a negative effect on tensile strength as well as elongation and DIN abrasion resistance (see FIGS. 6A-6B and Table 4):

TABLE 4
Physical Properties of Rubber Compositions
Containing Different Amounts
of Ground Cured Rubber

| | A0 | A0-11 | A0-33 |
|---|---|---|---|
| Hardness (Shore A) | 68 | 67 | 66 |
| 300% Modulus (kilograms | 37 | 36 | 39 |
| per square centimeter) | | | |
| Tensile Strength (kilograms | 134 | 115 | 93 |
| per square centimeter) | | | |
| Elongation (percent) | 832 | 754 | 595 |
| Tear Strength (kilograms | 86 | 59 | 53 |
| per centimeter) | | | |
| DIN Abrasion Resistance | 0.39 | — | 0.54 |
| (cubic centimeters) | | | |

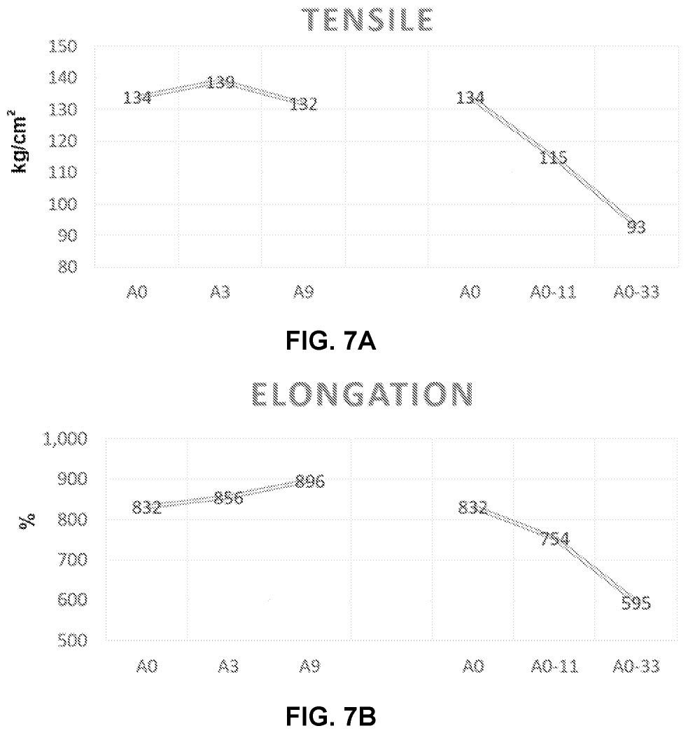

The presence of the macrocyclic polymer additive does not noticeably change tensile strength, although it has a positive effect on elongation. The macrocyclic polymer additive has a negative effect on DIN abrasion resistance, with hardness being slightly decreased (see FIGS. 7A-7B and Table 5):

TABLE 5
Physical Properties of Rubber Compositions
Containing Different Amounts
of Macrocyclic Polymer Additive

| | A0 | A3 | A9 |
|---|---|---|---|
| Hardness (Shore A) | 68 | 65 | 65 |
| 300% Modulus (kilograms | 37 | 39 | 31 |
| per square centimeter) | | | |
| Tensile Strength (kilograms | 134 | 139 | 132 |
| per square centimeter) | | | |
| Elongation (percent) | 832 | 856 | 896 |
| Tear Strength (kilograms | 86 | 67 | 63 |
| per centimeter) | | | |
| DIN Abrasion Resistance | 0.39 | 0.47 | 0.5 |
| (cubic centimeters) | | | |

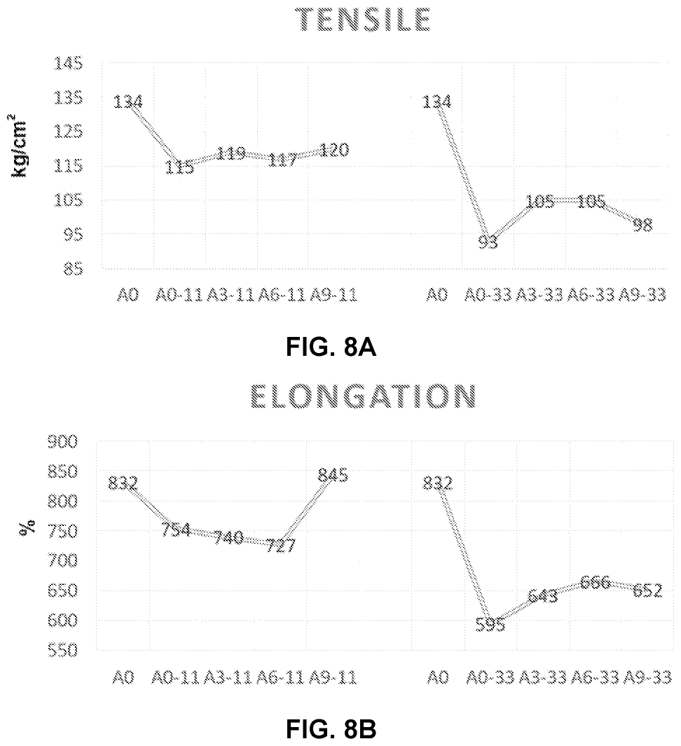

When both macrocyclic polymer additive and 11 phr ground cured rubber are present in compositions, there is no observable change in tensile strength. However, at 9 phr macrocyclic polymer additive, elongation is improved (see FIGS. 8A-8B and Table 6):

TABLE 6
Physical Properties of Rubber Compositions
Containing Different Amounts of Macrocyclic
Polymer Additive and 11 phr Ground Cured Rubber

| | A0 | A0-11 | A3-11 | A6-11 | A9-11 |
|---|---|---|---|---|---|
| Hardness (Shore A) | 68 | 65 | 66 | 66 | 66 |
| 300% Modulus (kilograms | 37 | 39 | 41 | 39 | 33 |
| per square centimeter) | | | | | |
| Tensile Strength (kilograms | 134 | 115 | 119 | 117 | 120 |
| per square centimeter) | | | | | |
| Elongation (percent) | 832 | 754 | 740 | 727 | 845 |
| Tear Strength (kilograms | 86 | 59 | 67 | 63 | 60 |
| per centimeter) | | | | | |
| DIN Abrasion Resistance | — | — | — | — | — |
| (cubic centimeters) | | | | | |

When both macrocyclic polymer additive and 33 phr ground cured rubber are present in compositions, both tensile strength and elongation increase with addition of macrocyclic polymer additive. The macrocyclic polymer additive has a positive effect on DIN abrasion resistance in these compositions, with hardness being slightly increased (see FIGS. 8A-8B and Table 7), with 9 phr of macrocyclic polymer additive being especially beneficial (see sample A9-33):

TABLE 7
Physical Properties of Rubber Compositions
Containing Different Amounts of Macrocyclic
Polymer Additive and 33 phr Ground Cured Rubber

| | A0 | A0-33 | A3-33 | A6-33 | A9-33 |
|---|---|---|---|---|---|
| Hardness (Shore A) | 68 | 65 | 68 | 69 | 70 |
| 300% Modulus (kilograms | 37 | 39 | 39 | 36 | 37 |
| per square centimeter) | | | | | |
| Tensile Strength (kilograms | 134 | 93 | 105 | 105 | 98 |
| per square centimeter) | | | | | |
| Elongation (percent) | 832 | 595 | 643 | 666 | 652 |
| Tear Strength (kilograms | 86 | 53 | 55 | 53 | 53 |
| per centimeter) | | | | | |
| DIN Abrasion Resistance | 0.39 | 0.54 | 0.49 | 0.49 | 0.48 |
| (cubic centimeters) | | | | | |

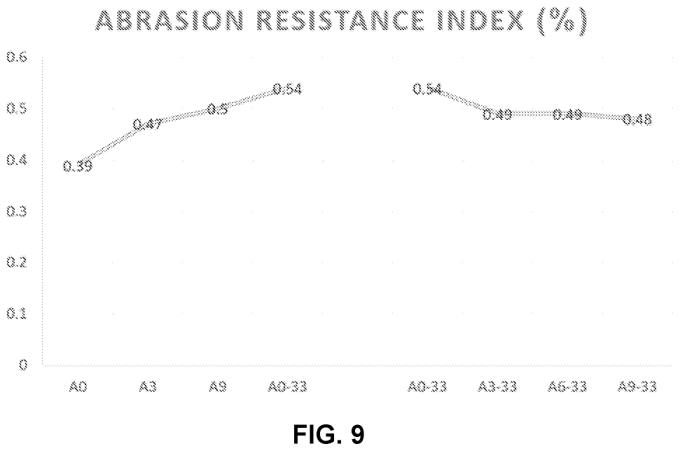

DIN Abrasion Resistance: The addition of ground cured rubber to the disclosed compositions tends to reduce DIN abrasion resistance because ground rubber acts as a non-reinforcing filler. The addition of macrocyclic polymer would also be expected to reduce DIN abrasion resistance since the strength of the macrocyclic polymer additive is relatively week. However, unexpectedly, in combination, the macrocyclic polymer additive and ground cured rubber improve DIN abrasion resistance synergetically. Without wishing to be bound by theory, ground cured rubber may be converted to reinforcing filler through surface modification (see FIG. 9 and Table 8):

TABLE 8
DIN Abrasion Resistance of Different Rubber Compositions

| | | | | A0- | A3- | A6- | A9- |
|---|---|---|---|---|---|---|---|
| | A0 | A3 | A9 | 33 | 33 | 33 | 33 |
| DIN Abrasion | 0.39 | 0.47 | 0.50 | 0.54 | 0.49 | 0.49 | 0.48 |
| Resistance | | | | | | | |
| Index (percent) | | | | | | | |

What is claimed is:

1. A rubber composition comprising:
a polymeric component, and
a curing package comprising sulfur and optionally a curing accelerator;
wherein the polymeric component comprises or consists of
100 parts of an uncured rubber component comprising at least one uncured rubber,
ground cured rubber, and
a macrocyclic polymer additive comprising a macrocyclic polymer.

2. The rubber composition of claim 1, wherein the rubber composition comprises at least 1 phr of the macrocyclic polymer additive.

3. The rubber composition of claim 1, wherein a ratio of phr of macrocyclic polymer additive to phr uncured rubber is from about 1:100 to about 2:5.

4. The rubber composition of claim 1, wherein a ratio of macrocyclic polymer additive to ground cured rubber is from about 1:40 to about 4:1.

5. The rubber composition of claim 1, wherein the macrocyclic polymer includes at least 24 carbon atoms bonded to each other in a ring structure by a plurality of carbon-carbon single bonds and a plurality of carbon-carbon double bonds.

6. The rubber composition of claim 5, wherein, in the plurality of carbon-carbon double bonds of the macrocyclic polymer, from about 60 to about 100% of the double bonds are in a trans configuration.

7. The rubber composition of claim 5, wherein, in the ring structure, a majority of the plurality of carbon-carbon double bonds are separated by from 4 to 12 singly bonded carbon atoms; or wherein each of the plurality of carbon-carbon double bonds are separated by 4 to 12 singly bonded carbon atoms; or a majority of the plurality of carbon-carbon double bonds occur every 8 carbon atoms; or individual bonds of the plurality of carbon-carbon double bonds occur every 8 carbon atoms.

8. The rubber composition of claim 1, wherein the macrocyclic polymer additive has a molecular weight of from about 50,000 g/mol to about 250,000 g/mol.

9. The rubber composition of claim 1, wherein the macrocyclic polymer comprises trans-polyoctenamer (TOR).

10. The rubber composition of claim 1, wherein the uncured rubber component comprises butyl rubber, styrene-butadiene rubber (SBR), isoprene rubber, chloroprene rubber, ethylene propylene diene monomer (EPDM) rubber, neoprene rubber, butadiene rubber, nitrile rubber, natural rubber, or any combination thereof.

11. The rubber composition of claim 1, wherein an average particle size of the ground cured rubber is of from about 25 to about 40 mesh.

12. The rubber composition of claim 1, wherein the ground cured rubber comprises or consists of ground recycled cured rubber.

13. The rubber composition of claim 1, wherein the ground cured rubber comprises less than 5 phr carbon black, or wherein the ground cured rubber is essentially free of byproducts of 2-mercaptobenzothiazole, or wherein the ground cured rubber comprises less than 5 phr carbon black and is essentially free of byproducts of 2-mercaptobenzothiazole.

14. The rubber composition of claim 1, wherein the rubber composition comprises from about 5 to about 40 phr ground cured rubber.

15. The rubber composition of claim 1, wherein the rubber composition further comprises from about 0.5 phr to about 5 phr of a process oil.

16. The rubber composition of claim 1, wherein the rubber composition further comprises an additive chosen from zinc oxide, a processing aid, an anti-oxidant, a wax, a homogenizer, a curing activator, a filler, a colorant, or any combination thereof.

17. The rubber composition of claim 1, wherein the curing package comprises from about 0.2 phr to about 10 phr of sulfur.

18. The rubber composition of claim 1, wherein the curing package comprises or consists of from about 0 phr to about 10 of the curing accelerator.

19. A cured rubber article comprising:
the vulcanized product of a rubber composition including
a polymeric component, and
a curing package comprising sulfur and optionally a curing accelerator;
wherein the polymeric component comprises or consists of
100 parts of an uncured rubber component comprising at least one uncured rubber,
at least 5 parts per hundred rubber (phr) ground cured rubber, and
at least 1 phr of a macrocyclic polymer additive comprising a macrocyclic polymer.

20. The cured rubber article of claim 19, wherein the cured rubber article is a component of an article of footwear, apparel or sporting equipment.
